(19) United States
(12) Patent Application Publication
(10) Pub. No.: US 2025/0148368 A1
(43) Pub. Date: May 8, 2025

(54) CONTOUR-BASED LOSS FUNCTION FOR MACHINE LEARNING

(71) Applicant: Senseonics, Incorporated, Germantown, MD (US)

(72) Inventor: Chad Michael Hicks, Germantown, MD (US)

(73) Assignee: Senseonics, Incorporated, Germantown, MD (US)

(21) Appl. No.: 18/932,855

(22) Filed: Oct. 31, 2024

Related U.S. Application Data
(60) Provisional application No. 63/596,664, filed on Nov. 7, 2023.

(51) Int. Cl. G06N 20/00

(52) U.S. Cl. CPC G06N 20/00

(57) ABSTRACT

Systems, apparatuses, and methods for training a machine learning (ML) model. Training the ML model may include using contour lines on a plot of prediction values to expected values to determine loss values indicative of errors between prediction values output by the ML model and corresponding expected values. The contour lines may be associated with loss values. Using the contour lines to determine the loss values may include, for each prediction value-expected value pair: generating a one-dimensional loss function through the prediction value-expected value pair, and using the one-dimensional loss function to determine a loss value for the prediction value-expected value pair. Training the ML model may include using an overall loss function to determine an overall loss of the ML model based on the determined loss values. Training the ML model may include adjusting the ML model to minimize the overall loss of the ML model.

### CROSS-REFERENCE TO RELATED APPLICATION

The present application claims the benefit of priority to U.S. Provisional Application Ser. No. 63/596,664, filed on Nov. 7, 2023, which is incorporated herein by reference in its entirety.

### BACKGROUND

### Field of Invention

The present invention relates generally to training a machine learning (ML) model. More particularly, the present invention relates to training an ML model using a loss function formed directly from a set of contour lines.

### Discussion of the Background

Loss functions are commonly used in supervised machine learning (ML) problems to define the optimization criteria that the ML training process will attempt to solve. As shown in FIG. 1, a loss function compares the predictions of an ML model with the expected values (i.e., the truth values) and returns some form of loss, which is a measure of the quality of the model predictions. Common loss functions include Mean Squared Error (MSE), Mean Absolute Error (MAE), and Cross-Entropy Loss. For example, MSE returns the mean of the squares of each prediction's error from expected value. One feature of these loss functions is that the loss value is dependent only on the relative difference between prediction and expected values. This makes them appropriate for a wide range of problems. An ML algorithm attempts to minimize the loss as calculated by the loss function in order to solve the ML problem.

A loss function generally returns the point-wise gradient and Hessian of the actual loss function (i.e., first and second order derivatives with respect to prediction, respectively) in order to inform the ML algorithm how to modify model parameters of the ML model in order to improve the ML model for the next iteration. In the case of MSE, the gradient is just twice the error, and the Hessian is the number two.

A common issue with the default loss functions is the assumption of symmetry. There are multiple ways to account for asymmetry. In classification, the misclassification loss can be directly set for each category. FIG. 2 shows an example of binary classification with classes A and B. In FIG. 2, loss is denoted by grayscale with white denoting larger loss and pure black indicating no loss. As shown in FIG. 2, misclassifying A as B has a different loss than classifying B as A.

In regression, the situation is more difficult as there are effectively an infinite number of possible errors, and the loss function must be defined as a function rather than as a grid of points. Even so, there are various approaches to dealing with loss asymmetry in regression. FIG. 3A shows a shaded plot of the MSE loss function. FIGS. 3B and 3C show the shaded plot of the MSE loss function along with common methods of introducing asymmetry. In FIGS. 3A-3C, larger loss is shown in lighter shades, and no loss is shown in black. In FIGS. 3A-3C, a cross-sectional line showing the slope from the upper right of the plot to the lower left is shown to the right of the contour plot.

FIG. 3A shows the default MSE plot. The cross section of the default MSE loss function is a simple parabola. FIG. 3B shows a variation of MSE in which a scaling factor is applied if the model underpredicts. This might be used, for example, if overprediction is viewed as having a worse outcome for the problem than underprediction. FIG. 3C shows a case where the MSE has been divided into multiple regions, and each region has its own MSE weighting. The techniques of FIGS. 3B and 3C could be combined to produce more complex asymmetries.

There may be cases where it is appropriate to use a more complex loss function than MSE. The broadest case is a generalized loss (GL) function defined as Loss=ƒ(x,y), where f Is an arbitrary 2D function. One specific example could be a loss function defined as

$$Loss = {( x - y )}^{2} - \frac{0.1}{( {( x - 0.5 )}^{2} + 0.1 )} ,$$

which is plotted in FIG. 4. The effect of the second term to the squared error loss is the creation of a region in the center where the error is largely irrelevant. This will train the resulting ML model to avoid errors near the low/high ranges of truth while ignoring those near the middle. A GL function might be used if extensive knowledge is had regarding the error-related performance of the system. This might occur, for example, in manufacturing tolerancing situations where the manufacturer is able to compare the actual end-product to what was designed for thousands of samples and identify how performance was affected. In practice, however, the use of generalized 2D loss functions is rather uncommon as machine learning practitioners often lack the prior knowledge and/or the data needed to customize to an arbitrary loss function, and this data is often expensive to acquire.

### SUMMARY

Between the situation of (a) a generalized loss (GL) function of the form Loss=ƒ(x,y) (specific to a given problem) and (b) the commonly used generic loss functions such as MSE, lies the case where a partial description of loss is available (e.g., in the scientific literature). This partial description may be expressed as a set of contours. Like the GL function, the set of contours can capture arbitrary asymmetry and complexity (given enough contours). A partial description of loss, which may be expressed as a set of contours, may be available, for example, where the original GL function (or two-dimensional (2D) data) has been reduced to a publishable format by a 3^{rd} party, and the original data either no longer exists or is inaccessible to a machine learning (ML) practitioner. In this situation, a generic loss function could be used but will most likely result in suboptimal performance of the final ML model due to the lack of published prior knowledge. Another option for this partial description of loss situation would be to use the contour information from the partial description to build an approximation of the original GL function.

A specific example where this partial description of loss situation arises is the Parkes Error Grid showing the clinical significance of glucose misprediction by a continuous glucose monitoring (CGM) system. The Parkes Error Grid is shown in FIG. 5 and is one of several consensus grids for glucose error significance estimation. It was developed by interviewing diabetes endocrinologists regarding the danger of glucose misestimation and creating a set of contours with qualitative descriptions of how dangerous a given misclassification would be. The published data consists of a set of vertices joined by straight lines. The vertices are defined such that x is the expected/true glucose value, and y is the estimated glucose value. The contours are both asymmetric and relatively complex compared to a simple function such as MSE. From the perspective of patient protection, incorporating this prior information when trying to estimate blood glucose is desirable. Further details regarding the Parkes Error Grid are available at A. Pfutzner, et. al., “Technical Aspects of the Parkes Error Grid,” J. of Diabetes Science and Technology, Vol 7-5 (September 2013).

Aspects of the invention may relate to forming a loss function (e.g., a regression loss function) for machine learning (ML) directly from a set of contour lines (e.g., of an arbitrary contour plot). Aspects of the invention may, for example and without limitation, provide the ability to describe more complex loss distributions when a contour-based description relating to loss is available (e.g., through published literature) but a more detailed 2D loss function is not available. Aspects of the invention may, for example, account for clinical practice results better than using a simpler function, such as mean-squared error. Aspects of the invention may, for example, closely represent patient risk in a situation where patient risk due to estimation error varies in a complex manner.

One aspect of the invention may provide a method for training a machine learning (ML) model. The method may include using contour lines on a plot of prediction values to expected values to determine loss values indicative of errors between prediction values output by the ML model and corresponding expected values. The contour lines may be associated with loss values. The method may include using an overall loss function to determine an overall loss of the ML model based on the determined loss values. The method may include adjusting the ML model to minimize the overall loss of the ML model.

In some aspects, the method may further include generating the contour lines, each of the contour lines may be generated based on a set of contour line pairs of prediction and expected values for the contour line, and each pair of the set of contour line pairs may define a vertex of the contour line. In some aspects, generating the contour lines may include, for each contour line, interpolating and/or extrapolating the contour line from the set of contour line pairs of prediction and expected values for the contour line. In some aspects, interpolating and/or extrapolating the contour lines may use linear interpolation (e.g., linear-piecewise fitting) and/or linear extrapolation. In some aspects, interpolating and/or extrapolating the contour lines may use non-linear interpolation and/or non-linear extrapolation.

In some aspects, each of the contour lines may be a function of prediction values to expected values. In some aspects, each of the contour lines may be a function of expected values to prediction values. In some aspects, each of the contour lines may be defined by parametric functions.

In some aspects, using the contour lines to determine the loss values may include, for each prediction value-expected value pair of the prediction values output by the ML model and the corresponding expected values: generating a one-dimensional loss function through the prediction value-expected value pair; and using the one-dimensional loss function to determine a loss value for the prediction value-expected value pair. In some aspects, generating the one-dimensional loss function through the prediction value-expected value pair may include determining intersection points including at least a first intersection point at which a line through the prediction value-expected value pair intersects with a first contour line of the contour lines and a second intersection point at which the line through the prediction value-expected value pair intersects with a second contour line of the contour lines.

In some aspects, the first intersection point may include a prediction value of the first contour line having the expected value of the prediction value-expected value pair, the second intersection point may include a prediction value of the second contour line having the expected value of the prediction value-expected value pair, and using the one-dimensional loss function to determine the loss value for the prediction value-expected value pair may include using at least the prediction values of the first and second intersection points and the loss values associated with the first and second contour lines to determine the loss value for the prediction value of the prediction value-expected value pair. In some aspects, determining the first and second intersection points may include, for each of the first and second contour lines: (i) if the expected value of the prediction value-expected value pair is within a range of the expected values of a set of contour line pairs of prediction and expected values of the contour line with each pair of the set of contour line pairs defining a vertex of the contour line, using interpolation to determine the prediction value of the contour line having the expected value of the prediction value-expected value pair, and (ii) if the expected value of the prediction value-expected value pair is outside the range of the expected values of the set of contour line pairs of prediction and expected values of the contour line, using extrapolation to determine the prediction value of the contour line having the expected value of the prediction value-expected value pair.

In some aspects, the first intersection point may include an expected value of the first contour line having the prediction value of the prediction value-expected value pair, the second intersection point may include an expected value of the second contour line having the prediction value of the prediction value-expected value pair, and using the one-dimensional loss function to determine the loss value for the prediction value-expected value pair may include using at least the expected values of the first and second intersection points and the loss values associated with the first and second contour lines to determine the loss value for the expected value of the prediction value-expected value pair. In some aspects, determining the first and second intersection points may include, for each of the first and second contour lines: (i) if the predicted value of the prediction value-expected value pair is within a range of a set of contour line pairs of prediction and expected values of the contour line with each pair of the set of contour line pairs defining a vertex of the contour line, using interpolation to determine the expected value of the contour line having the predicted value of the prediction value-expected value pair, and (ii) if the predicted value of the prediction value-expected value pair is outside the range of the predicted values of the set of contour line pairs of prediction and expected values of the contour line, using extrapolation to determine the expected value of the contour line having the predicted value of the prediction value-expected value pair.

In some aspects, the line through the prediction value-expected value pair may be neither vertical nor horizontal.

In some aspects, generating the one-dimensional loss function may include interpolating and/or extrapolating the one-dimensional loss function from at least the first and second intersection points. In some aspects, interpolating and/or extrapolating the one-dimensional loss function may use linear interpolation and/or linear extrapolation. In some aspects, interpolating and/or extrapolating the one-dimensional loss function may use non-linear interpolation and/or non-linear extrapolation.

In some aspects, the one-dimensional loss function may be a function of prediction value to loss value, and the one-dimensional loss function may determine the loss value for the prediction value of the prediction value-expected value pair. In some alternative aspects, the one-dimensional loss function may be a function of expected value to loss value, and the one-dimensional loss function may determine the loss value for the expected value of the prediction value-expected value pair.

In some aspects, the method may further include determining a slope of the one-dimensional loss function at the prediction value-expected value pair. In some aspects, adjusting the ML model may include using an optimization algorithm to optimize the ML model's parameters with the determined loss values being used as gradients and the determined slopes of the one-dimensional loss functions at the prediction value-expected value pairs being used as Hessians. In some aspects, the optimization algorithm may be a gradient descent algorithm, a stochastic gradient descent algorithm, or an Adam optimization algorithm.

In some aspects, the overall loss function may be a regression loss function. In some aspects, the overall loss function may be a mean square error loss function. In some aspects, the overall loss function may be a mean absolute error loss function, a mean bias error loss function, a hinge loss function, or a cross-entropy loss function. In some aspects, the overall loss function may be a classification loss function.

In some aspects, adjusting the ML model to minimize the overall loss of the ML model may include modifying one or more parameters of the ML model.

In some aspects, using the overall loss function to determine the overall loss of the ML model may include squaring the determined loss values, summing the squared determined loss values, and calculating a square root of the sum.

In some aspects, the contour lines may express an arbitrary loss for regression. In some aspects, the contour lines may account for arbitrary asymmetry. In some aspects, the contour lines may account for clinical practice results. In some aspects, the contour lines may correspond to a clinical significance of glucose misprediction. In some aspects, the contour lines may correspond to areas of a Parkes Error Grid. In some aspects, the contour lines may correspond to areas of Clark Error Grid.

Another aspect of the invention may provide an apparatus including processing circuitry and a memory containing instructions executable by the processing circuitry. The apparatus may be operative to perform any of the methods described above.

Still another aspect of the invention may provide an apparatus adapted to perform any of the methods described above.

Yet another aspect of the invention may provide a machine learning (ML) model training system. The ML model training system may be configured to use contour lines on a plot of prediction values to expected values to determine loss values indicative of errors between prediction values output by the ML model and corresponding expected values. The contour lines may be associated with loss values. The ML model training system may be configured to use an overall loss function to determine an overall loss of the ML model based on the determined loss values. The ML model training system may be configured to adjust the ML model to minimize the overall loss of the ML model.

In some aspects, the apparatus may include processing circuitry and a memory, the memory may include instructions executable by the processing circuitry, the apparatus may be operative to perform the loss values determining, the overall loss determining, and the ML model adjusting.

Further variations encompassed within the systems and methods are described in the detailed description of the invention below.

### BRIEF DESCRIPTION OF THE DRAWINGS

The accompanying drawings, which are incorporated herein and form part of the specification, illustrate various, non-limiting embodiments of the present invention. In the drawings, like reference numbers indicate identical or functionally similar elements.

FIG. 1 illustrates a loss function that compares the predictions of an ML model with the expected values (i.e., the truth values) and returns some form of loss, which is a measure of the quality of the model predictions.

FIG. 2 illustrates an example of binary classification with classes A and B.

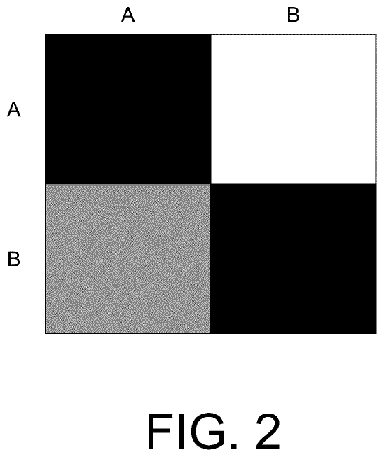

FIG. 3A illustrates a shaded plot of a default Mean Squared Error (MSE) loss function.

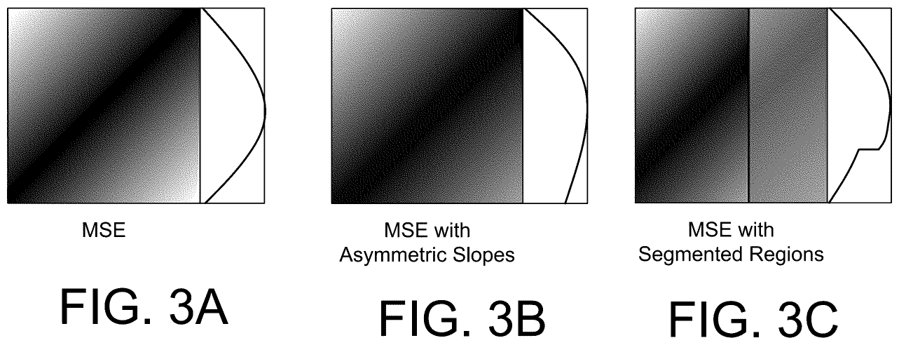

FIG. 3B illustrates a shaded plot of a variation of the MSE loss function in which asymmetry is introduced by applying a scaling factor if the model underpredicts.

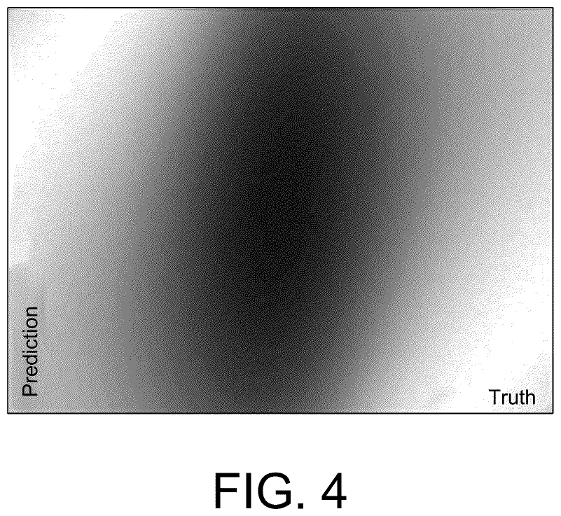

FIG. 3C illustrates a shaded plot of a variation of the MSE loss function in which asymmetry is introduced by dividing the MSE into multiple regions with each region having its own MSE weighting.

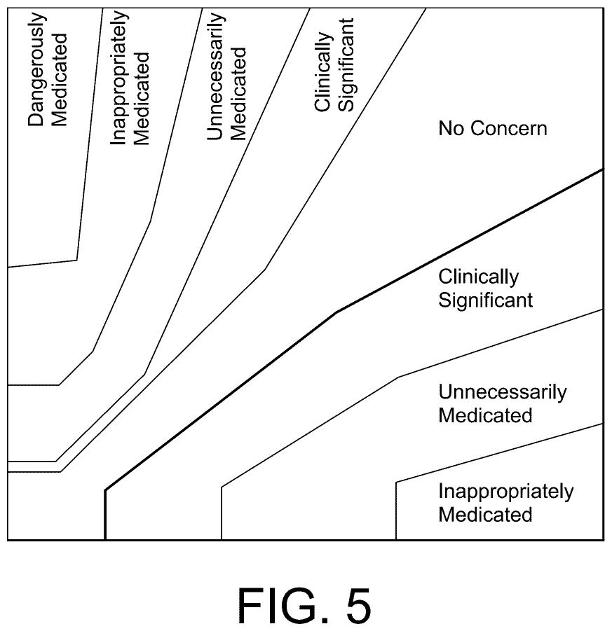

FIG. 4 illustrates a specific example of a generalized loss (GL) function defined as Loss=ƒ(x,y), where f Is an arbitrary 2D function.

FIG. 5 illustrates a Parkes Error Grid.

FIG. 6 is a schematic view illustrating an exemplary machine learning (ML) model training system according to some aspects.

FIGS. 7A-7D illustrate examples of contour lines defined by sets of vertices and generated using linear interpolation and/or linear extrapolation, contour lines defined by sets of vertices and generated using non-linear interpolation and/or non-linear extrapolation, contour lines defined by functions of the form y=(x), and contour lines defined parametrically, respectively, according to some aspects.

FIGS. 8A-8C illustrate example lines through the prediction value-expected value pair that are a vertical line having the expected value of the prediction value-expected value pair, a horizontal line having the prediction value of the prediction value-expected value pair, and a diagonal line, respectively, according to some aspects.

FIGS. 9A-9C illustrate an example of a set of loss function vertices, an example of a one-dimensional (1D) loss function generated based on the set of loss function vertices, and an example of using the 1D loss function to determine a loss value according to some aspects.

FIG. 10 is a flowchart illustrating a process for training an ML model according to some aspects.

FIG. 11 is a flowchart illustrating a process for using contour lines to determine loss values according to some aspects.

FIG. 12 is a schematic view illustrating an exemplary analyte monitoring system according to some aspects.

FIG. 13 is a schematic view illustrating an exemplary analyte sensor of the analyte monitoring system according to some aspects.

FIG. 14 is a schematic view illustrating an exemplary transceiver of the analyte monitoring system according to some aspects.

FIG. 15 is a schematic view illustrating an exemplary display device of the analyte monitoring system according to some aspects.

FIG. 16 is a schematic view illustrating an exemplary computer of the ML model training system or the analyte monitoring system according to some aspects.

### DETAILED DESCRIPTION OF PREFERRED EMBODIMENTS

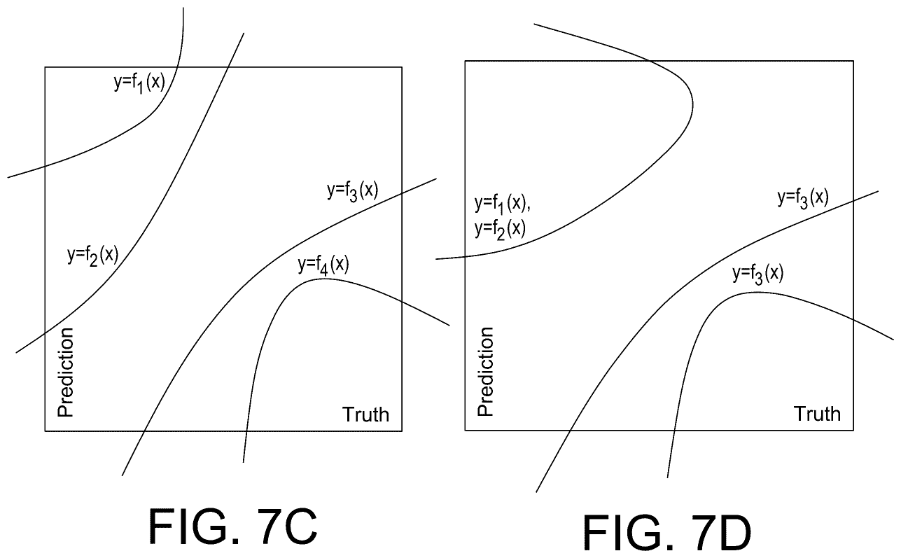

FIG. 6 is a schematic view of an exemplary machine learning (ML) model training system 600 embodying aspects of the present invention. In some aspects, the model training system 600 may include an ML model 602, training data storage device 604, contour line data storage device 606, a loss value generator 608, and/or an ML optimizer 510. In some aspects, the ML model training system 600 may train the ML model 602 using a loss function formed directly from a set of contour lines. In some aspects, the ML model training system 600 may use information about the set of contour lines to approximate a two-dimensional (2D) loss function underlying the contour lines (e.g., when the 2D loss function is otherwise not available). In some aspects, the ML model training system 600 may use the approximated 2D loss function to train the ML model 602. In some aspects, the ML model training system 600 may determine loss for a specific prediction value-expected value pair without having to go through the computational cost of approximating the underlying 2D loss function for all possible prediction value-expected value pairs.

In some aspects, the training data storage device 604 may include one or more non-volatile storage devices and/or one or more volatile storage devices (e.g., random access memory (RAM)). In some aspects, the training data storage device 604 may store a training data set for training the ML model 602. In some aspects, the training data set may include ML model inputs and expected values for the ML model inputs. In some aspects, the ML model 602 may include one or more model parameters 612. In some aspects, the ML model 602 may receive one or more model inputs from the training data storage device 604 and generate a prediction value. In some aspects, the loss value generator 608 may receive the prediction value output by the ML model 602 and the corresponding expected value, which may be the value expected for the one or more model inputs used by the ML model 602 to generate the prediction value. In some aspects, the loss value generator 608 may determine a loss value indicative of an error between the prediction value and the corresponding expected value. In some aspects, the process may be repeated for the rest of the ML model inputs and expected values of the training data set, and the loss value generator 608 may determine loss values indicative of errors between prediction values output by the ML model 602 and the corresponding expected values. In some aspects, the ML optimizer 610 may receive the determined loss values and use an overall loss function to determine an overall loss of the ML model 602 based on the determined loss values. In some aspects, the ML optimizer 610 may adjust the ML model 602 to minimize the overall loss of the ML model 602. In some aspects, adjusting the ML model 602 to minimize the overall loss of the ML model 602 may include modifying one or more of the one or more model parameters 612 of the ML model 602.

In some aspects, the loss value generator 608 may use contour lines on a plot of prediction values to expected values to determine the loss values indicative of the errors between prediction values output by the ML model 602 and the corresponding expected values. In some aspects, the contour lines may be contour line functions (e.g., functions of prediction values to expected values or functions of expected values to prediction values). In some aspects, the contour lines may be associated with loss values. In some aspects, as shown in FIG. 6, the loss value generator 608 may receive contour line definitions and associated loss values. In some aspects, the loss value generator 608 may receive the contour line definitions and the associated loss values from a contour line data storage device 606, which may store the contour line definitions and the associated loss values. In some aspects, the contour line data storage device 606 may include one or more non-volatile storage devices and/or one or more volatile storage devices (e.g., RAM).

In some aspects, the ML model 602 may predict blood glucose levels. That is, in some aspects, the prediction values generated by the ML model 602 may be predicted blood glucose levels. In some blood glucose level prediction aspects, the ML model inputs may include one or more interstitial fluid (ISF) glucose levels and associated time stamps. For example, in some aspects, the one or more ISF glucose levels may include a first ISF glucose level at a first time (e.g., to) and one or more previous ISF glucose levels at times (e.g., t₋₅, t₋₁₀, t₋₁₅, t₋₂₀, t₋₂₅) prior to the first time. In some blood glucose level prediction aspects, the ML model 602 may predict a blood glucose level at the first time (e.g., to), and, in some alternative blood glucose level prediction aspects, the ML model 602 may predict a blood glucose level at a future time (e.g., t₊₅, t₊₁₀, t₊₁₅, or t₊₂₀) relative to the first time. In some blood glucose level prediction aspects, the corresponding expected value may be an expected blood glucose level for the time (e.g., the first time or the future time) at which blood glucose level was predicted. In some aspects, the expected blood glucose levels may be capillary blood glucose levels (e.g., self-monitoring blood glucose (SMBG) levels obtained finger sticks and a blood glucose meter) or venous blood glucose levels (e.g., obtained by a biochemistry analyzer such as a YSI glucose analyzer).

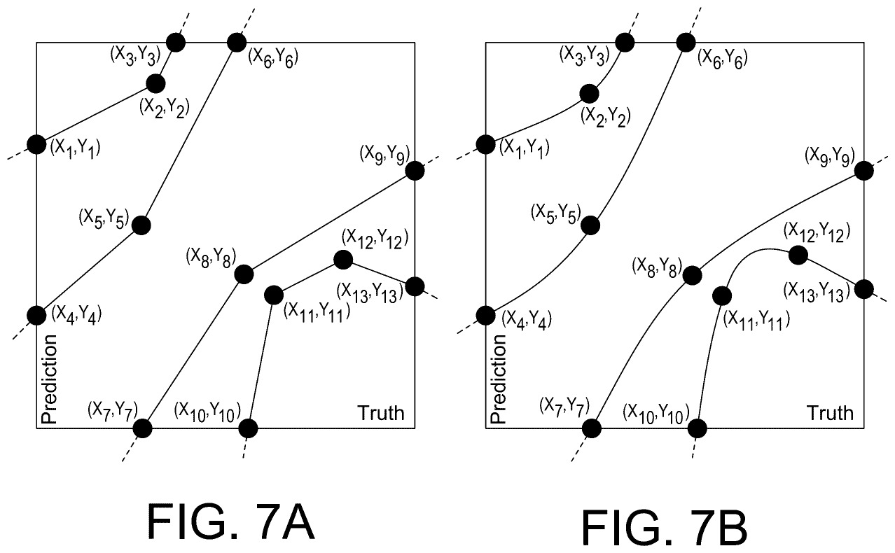

In some blood glucose level prediction aspects, the loss value generator 608 may develop a loss function from contour lines that are based on the Parkes Error Grid (e.g., as shown in FIG. 5). In some aspects, the contour lines used by the loss value generator 608 to determine loss values may correspond to the lines defining the boundaries of the regions of the qualitative medical concern categories of the Parkes Error Grid. In some aspects, the contour lines based on the boundaries of the regions of the qualitative medical concern categories of the Parkes Error Grid may each be assigned or otherwise associated with a numeric loss value. In some alternative aspects, loss functions may be developed for blood analyte levels other than glucose (e.g., oxygen) and/or for different applications/use cases. That is, aspects of the invention would apply to any data or theoretical equations that could be used to form contours.

For an example of alternative applications, many modern pacemakers are designed to anticipate the needed heart pacing based on, for example and without limitation, detected movement. Miscalculating the ideal heart pacing could cause short or long-term side effects, and the risk of the side effects increases with increasing error. Error risks for different side effects could be published as risk contours (e.g., 5% risk, 10% risk, etc.). In some aspects, the loss value generator 608 may use contour lines associated with the risk of side effects to determine loss values for training the ML model 602 to calculate heart pacing based on at least the detected movement. For another example of alternative applications, military missiles often use the concept of a “shot box” to define the locations in which a missile is likely to hit its target. Due to the complexity of the actual calculations, the shot box boundary or probability thresholds are often provided as contours. In warfare, the target may have significant positional uncertainty due to electronic warfare and other forms of deception. In some aspects, the shot box and expected positional uncertainties may be combined to form performance contours. In some aspects, the loss value generator 608 may use the contour lines associated with performance to determine loss values for training the ML model 602 to calculate missile release time. For still another example of alternative applications, computer chips have tight manufacturing tolerances. These tolerances become stricter for higher performance (e.g., higher clock frequency) versions of the same chip. In some aspects, a manufacturer may define risk contours for a specific manufacturing variable (e.g., gate thickness), and the loss value generator 608 may use the contour lines associated with the risk for training the ML model 602 to control manufacturing of that variable (e.g., the gate deposition process).

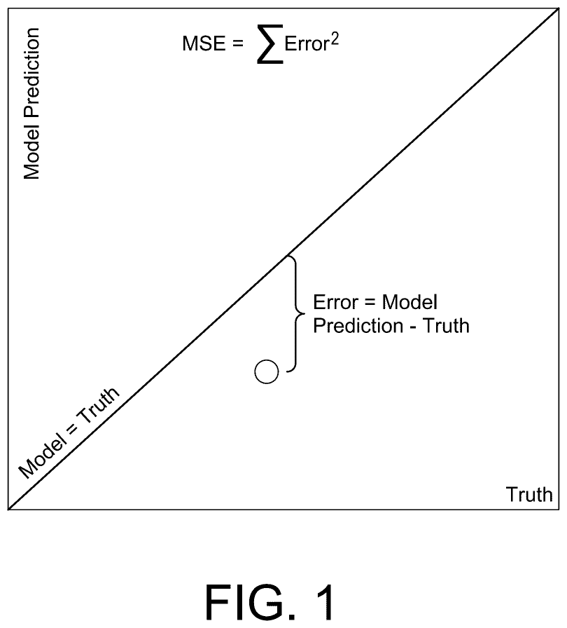

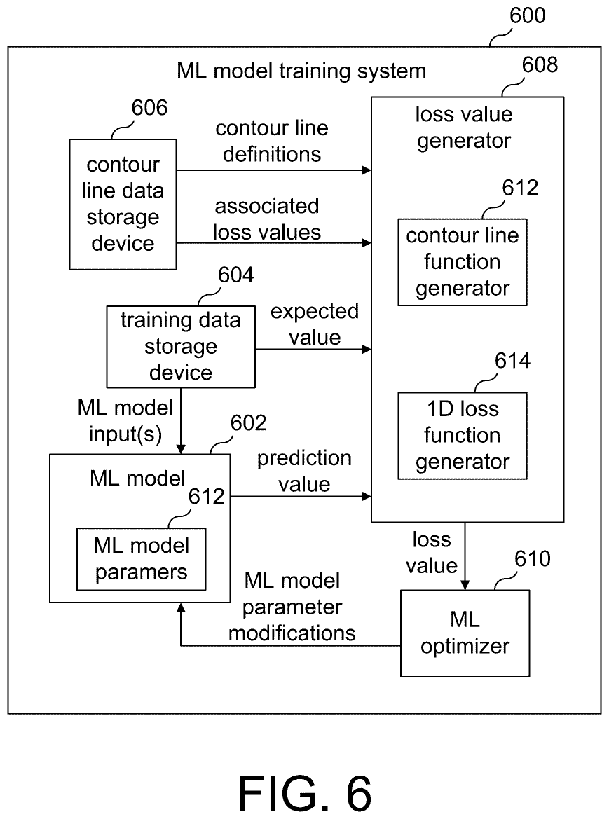

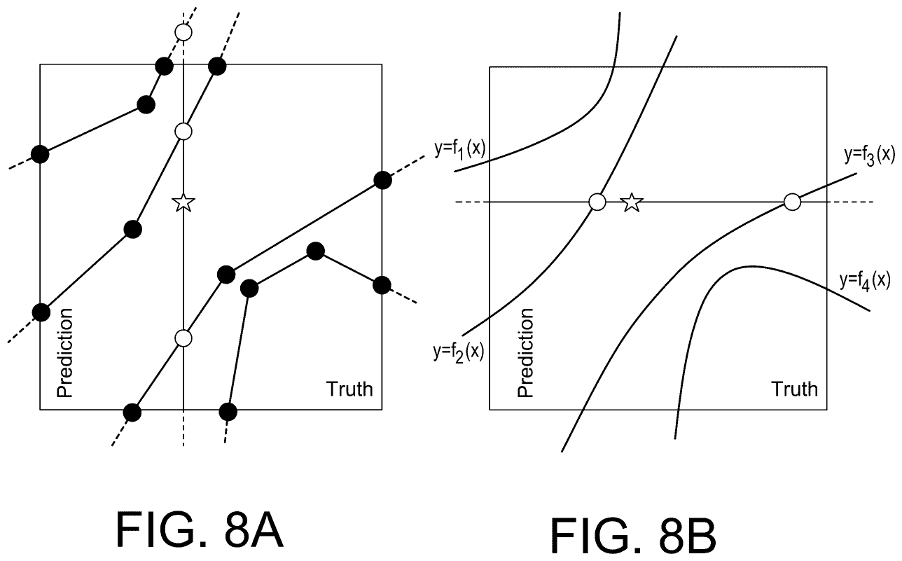

In some aspects, the contour line definitions received by the loss value generator 608 (e.g., from the contour line data storage device 606) may be (i) a set of interpolated vertices, (ii) functions in the form y=f(x), or (iii) parametric functions in the form y=f₁(t), x=f₂(t). FIGS. 7A-7D show four examples of contour lines. In FIG. 7A, contour lines are defined by sets of vertices, and the loss value generator 608 may generate the contour lines using linear interpolation and/or linear extrapolation. In FIG. 7B, contour lines are defined by sets of vertices, and the loss value generator 608 may generate the contour lines using non-linear interpolation and/or non-linear extrapolation (e.g., quadratic, spline, etc). In FIG. 7C, contour lines are not defined by vertices and are instead defined by functions of the form y=(x). In FIG. 7D, the contour lines are defined parametrically. In some aspects, as shown in FIG. 6, the loss value generator 608 may include a contour line function generator 612 that generates contour line functions based on the contour line definitions (e.g., when the contour line definitions do not include contour line functions and instead define contour lines based on the sets of vertices as shown in FIGS. 7A and 7B). In some aspects, the contour lines used by the loss value generator 104 to determine loss values may include (i) one or more contour lines generated by the contour line function generator 612 interpolating and/or extrapolating from one or more sets of vertices, (ii) one or more contour lines defined by functions of the form y=(x), and/or (iii) one or more contour lines defined by parametric functions. Although the figures (e.g., FIGS. 1, 4, 5, and 7A-7D) associate the x-axis with truth and the y-axis with ML model prediction, this association is arbitrary, and, in some alternative aspects, the axis associations may be reversed.

In some aspects, training the ML model 602 may include the loss value generator 608 receiving (i) definitions of contour lines and (ii) loss/cost values associated with the contour lines as inputs. In some aspects, the loss value generator 608 may receive the contour line definitions and the associated loss values from the contour line data storage device 606. In some aspects (e.g., the aspects shown in FIGS. 7A and 7B), the contour line definitions may include coordinates of the vertices of the contour lines. In some aspects, the contour line vertex coordinates may be obtained from published literature. However, this is not required, and, in some alternative aspects, the contour line vertex coordinates may be obtained from data that has not been published. In some aspects (e.g., the aspects shown in FIGS. 7C and 7D), the contour line definitions may include the contour function or parametric contour function definition for each contour line.

In some aspects in which the contour line definitions include vertex coordinates of the contour lines (e.g., the aspects shown in FIGS. 7A and 7B), the inputs may additionally include an identification of the scheme to be used by the loss value generator 608 (e.g., by the contour line function generator 612 of the loss value generator 608) in interpolating and/or extrapolating the contour lines from the sets of vertex coordinates. However, this is not required, and, in some alternative aspects, the loss value generator 608 (e.g., the contour line function generator 612 of the loss value generator 608) may use a default scheme.

In some aspects, training the ML model 602 may include the loss value generator 608 receiving prediction values output by the ML model 602 and corresponding expected values. In some aspects, the corresponding expected values may be received from the training data storage device 604. In some aspects, the prediction values output by the ML model 602 and the corresponding expected values may be in the form of prediction value-expected value pairs. In some aspects, the prediction value-expected value pairs may be in the form of (X, Y) coordinates with the y value being a prediction value output by the ML model and the x value being the corresponding expected value. Although aspects of the invention are described below with the y value being a prediction value output by the ML model and the x value being the corresponding expected value, this is not required, and, in some alternative aspects, the x value may be a prediction value output by the ML model, and the y value may be the corresponding expected value.

In some aspects, at a high-level, training the ML model 602 may include the loss value generator 608, given the contour line definitions, loss values associated with the contour lines, and the prediction value-expected value pairs (e.g., in the form of (X,Y) coordinates), finding the loss between the predication values output by the ML model 602 and the corresponding expected values. In some aspects in which the contour line definitions specify contour lines as sets of vertices (e.g., the aspects shown in FIGS. 7A and 7B), training the ML model 602 may include the contour line function generator 612 converting the sets of vertices into contour line functions (e.g., of the form y=f(x) or y=f(t), x=f(t) as appropriate). In some alternative aspects (e.g., the aspects shown in FIGS. 7C and 7D), the contour line definitions may specify the contour line functions (e.g., of the form y=f(x) or y=f(t), x=f(t) as appropriate), and generation of contour line functions by a contour line function generator 612 may not be necessary.

In some aspects, training the ML model 602 may include the loss value generator 608, for each of the prediction value-expected value pairs, constructing a one-dimensional (1D) loss function through the prediction value-expected value pair (e.g., through the (X, Y) point). In some aspects, the loss value generator 608 may include a 1D loss function generator 614 that generates the 1D loss function through the prediction value-expected value pair. In some aspects, the 1D loss function generator 614 may construct the 1D loss function using some form of line fitting. In some aspects, training the ML model 602 may include the loss value generator 608, for each of the prediction value-expected value pairs, determining the loss at the prediction value-expected value pair. In some aspects, training the ML model 602 may include the loss value generator 608, for each of the prediction value-expected value pairs, providing the determined loss value to a machine learning optimization algorithm 610 and updating the ML model 602.

In some aspects (e.g., the aspects shown in FIGS. 7A and 7B) in which (i) each of the contour lines is defined by a set of contour line pairs of prediction and expected values for the contour line that define vertices of the contour line and (ii) training the ML model 602 includes the contour line function generator 612 generating the contour lines, generating the contour lines may include converting the sets of vertices of the contour lines to functional forms. In some aspects, some form of interpolation or function fitting may be used to convert a set of vertices into a function (e.g., a function that can be intersected with the a 1D loss function through a prediction value-expected value pair when determining the loss at the prediction value-expected value pair). There are many ways of converting a set of vertices into a function. In some set of contour line vertices aspects (e.g., the aspect shown in FIG. 7A), the contour line function generator 612 may use linear-piecewise fitting convert a set of vertices into a function. In some linear-piecewise fitting aspects, the portion of the contour line between consecutive vertices of the contour line may be fit using the standard equations for a line. For example, the contour line function generator 612 may fit the contour line between consecutive vertices (x₁, y₁) and (x₂, y₂) in FIG. 7A using the following standard equations for a line:

$$m = \frac{{y}_{2} - {y}_{1}}{{x}_{2} - {x}_{1}}$$

$$b = {y}_{2} - m {x}_{2} or b = {y}_{1} - m {x}_{1}$$

$$y = mx + b$$

The result of this operation may be a y=mx+b equation for the portion of the contour line between the consecutive vertices. In some alternative aspects, the definitions of the x-axis and y-axis may be reversed (e.g., the x-axis may be prediction values, and the y-axis may be expected values).

In the example shown in FIG. 7A, (1) a first contour line is defined by a first set of contour line pairs of prediction and expected values (x₁, y₁), (x₂, y₂), and (x₃, y₃), which define the vertices of the first contour line, (2) a second contour line is defined by a second set of contour line pairs of prediction and expected values (x₄, y₄), (x₅, y₅), and (x₆, y₆), which define the vertices of the second contour line, (3) a third contour line is defined by a third set of contour line pairs of prediction and expected values (x₇, y₇), (x₈, y₈), and (x₉, y₉), which define the vertices of the third contour line, and (4) a fourth contour line is defined by a fourth set of contour line pairs of prediction and expected values (x₁₀, y₁₀), (x₁₁, y₁₁), (x₁₂, y₁₂), and (x₁₃, y₁₃), which define the vertices of the fourth contour line. In some linear-piecewise fitting aspects (e.g., the aspect shown in FIG. 7A), the portions of the first contour line between consecutive vertices of the first contour line (e.g., between (x₁, y₁) and (x₂, y₂) and between (x₂, y₂) and (x₃, y₃)), the portions of the second contour line between consecutive vertices of the second contour line (e.g., between (x₄, y₄) and (x₅, y₅) and between (x₅, y₅) and (x₆, y₆)), the portions of the third contour line between consecutive vertices of the third contour line (e.g., between (x₇, y₇) and (x₈, y₈) and between (x₈, y₈) and (x₉, y₉)), and the portions of the fourth contour line between consecutive vertices of the fourth contour line (e.g., between (x₁₀, y₁₀) and (x₁₁, y₁₁), between (x₁₁, y₁₁) and (x₁₂, y₁₂), and between (x₁₂, y₁₂) and (x₁₃, y₁₃)) may be fit using the standard equations for a line.

In some alternative set of contour line vertices aspects (e.g., the aspect shown in FIG. 7B), non-linear interpolation may be used to convert a set of vertices into a function. In some non-linear contour line interpolation aspects, the non-linear interpolation may be, for example and without limitation, polynomial, quadratic, spline, or k-nearest neighbor (KNN) interpolation. In some non-linear contour line interpolation aspects, the result of the non-linear interpolation may be a y=a₀+a₁x+a₂x²+ . . . +aₙxⁿ equation for the contour line. In some alternative aspects, the definitions of the x-axis and y-axis may be reversed (e.g., the x-axis may be prediction values, and the y-axis may be expected values).

In the example shown in FIG. 7B, the first through fourth contour lines are defined as in FIG. 7A. In some non-linear contour line interpolation aspects (e.g., the aspect shown in FIG. 7B), the contour line function generator 612 may use non-linear interpolation to convert (1) the first set of contour line pairs of prediction and expected values (x₁, y₁), (x₂, y₂), and (x₃, y₃) into a function for the first contour line, (2) the second set of contour line pairs of prediction and expected values (x₄, y₄), (x₅, y₅), and (x₆, y₆) into a function for the first contour line, (3) the set of contour line pairs of prediction and expected values (x₇, y₇), (x₈, y₈), and (x₉, y₉) into a function for the third contour line, and (4) the fourth set of contour line pairs of prediction and expected values (x₁₀, y₁₀), (x₁₁, y₁₁), (x₁₂, y₁₂), and (x₁₃, y₁₃) into a function for the fourth contour line.

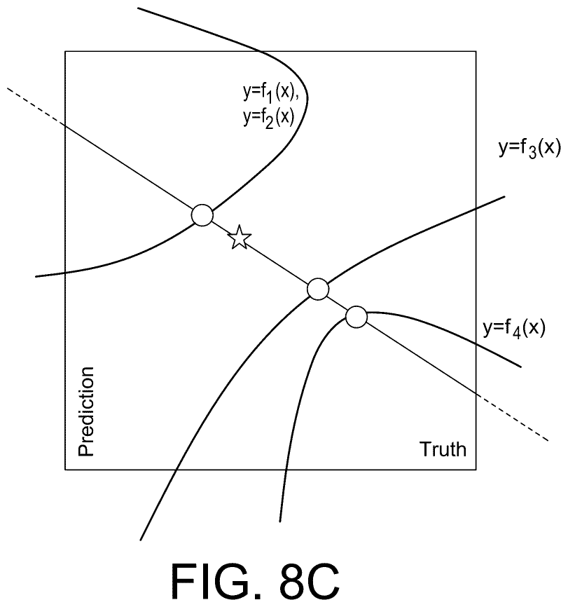

In some aspects, constructing a 1D loss function through a prediction value-expected value pair (e.g., an (X,Y) point) may include the loss value generator 608 (e.g., the 1D loss function generator 614 of the loss value generator 608) determining, for each contour line, the point at which a line through the prediction value-expected value pair intersects the contour line. FIGS. 8A-8C show examples of the line through the prediction value-expected value pair according to various aspects. In some aspects, the prediction value-expected value pair may be a prediction value output by the ML model 602 and the corresponding expected value for which the loss value generator 608 is determining the loss value. In FIGS. 8A-8C, the prediction value-expected value pair is shown as a star. In some aspects, as shown in FIG. 8A, the line through the prediction value-expected value pair may be a vertical line having the expected value of the prediction value-expected value pair. In some alternative aspects, as shown in FIG. 8B, the line through the prediction value-expected value pair may be a horizontal line having the prediction value of the prediction value-expected value pair. In some further alternative aspects, as shown in FIG. 8C, the line through the prediction value-expected value pair may have an arbitrary angle (e.g., the line through the prediction value-expected value pair may be a diagonal line).

In some aspects, various mathematical equations and methods for determining an intersection point between two lines are known and may be used (e.g., by the 1D loss function generator 614 of the loss value generator 608) to determine the intersection points of the line through the prediction value-expected value pair and the contour lines. In some aspects in which (i) linear-piecewise fitting was used to determine the portions of contour lines between consecutive contour line vertices and (ii) the line through the prediction value-expected value pair is a vertical line (e.g., as shown in FIG. 8A), if the expected value of the prediction value-expected value pair for which the loss value generator 608 is to determine a loss value is within a range of the expected values of the set of contour line vertices of a contour line, the 1D loss function generator 614 may use the line equation y=mx+b that the contour line function generator 612 formed from the two consecutive contour line vertices closest in expected value to the expected value of the prediction value-expected value pair to determine as the intersection point the prediction value of the contour line having the expected value of the prediction value-expected value pair. In some aspects in which (i) linear-piecewise fitting was used to determine the portions of contour lines between consecutive contour line vertices and (ii) the line through the prediction value-expected value pair is a vertical line (e.g., as shown in FIG. 8A), if the expected value of the prediction value-expected value pair for which the loss value is to be determined is outside the range of the expected values of the set of contour line vertices of a contour line, the loss function generator 608 may use extrapolation to determine the prediction value of the contour line having the expected value of the prediction value-expected value pair. In FIG. 8A, the extrapolated contour lines, which may be extrapolated from the contour line vertices (e.g., from the two contour line vertices closest in expected value to the expected value of the prediction value-expected value pair), are shown in dashed lines.

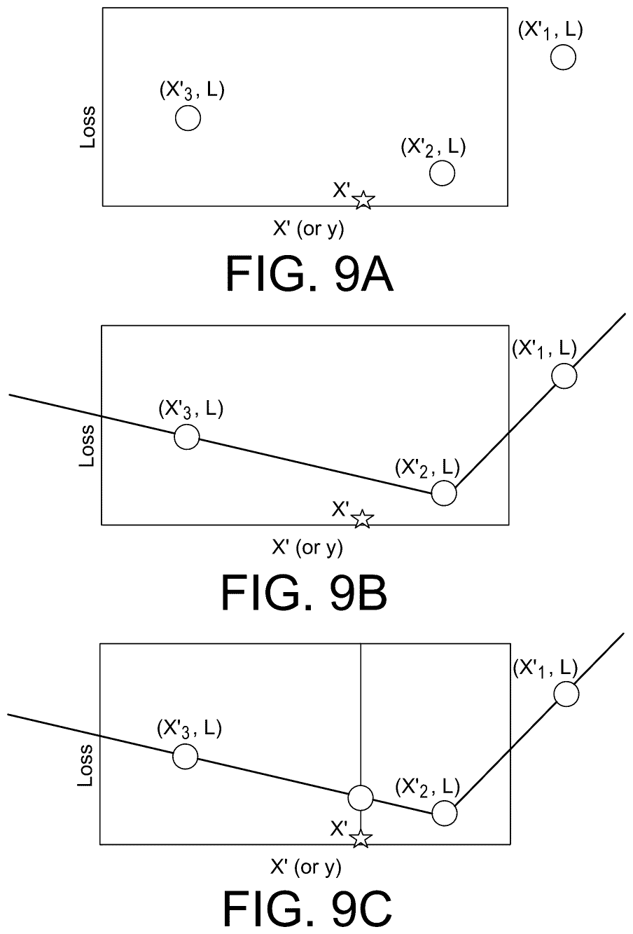

In some aspects, as shown in FIG. 9A, the loss function generator 608 (e.g., the 1D loss function generator 614 of the loss function generator 608) may use the determined intersection points to produce a set of loss function vertices (X′ₙ, Lₙ), where X′ₙ is the position of the intersection of the line through the prediction value-expected value pair with the nth contour line along the one dimensional loss function, and Ln is the loss value associated with the nth contour line. In some aspects in which the line through the prediction value-expected value pair is a vertical line (e.g., as shown in FIG. 8A), the X′ₙ may be the prediction value of the nth contour line at the expected value of the prediction value-expected value pair. In some aspects in which the line through the prediction value-expected value pair is a horizontal line (e.g., as shown in FIG. 8B), the X′ₙ may be the expected value of the nth contour line at the prediction value of the prediction value-expected value pair.

In some aspects, the loss function generator 608 (e.g., the 1D loss function generator 614 of the loss function generator 608) may convert the set of loss function vertices (e.g., as shown in FIG. 9A) to a loss function in the form of L=ƒ(x′) (e.g., as shown in FIG. 9B). There are many ways to convert the set of loss function vertices to a loss function. In some aspects, the 1D loss function generator 614 may use piecewise linear fitting, which corresponds to linear interpolation and/or linear extrapolation, to convert the set of loss function vertices to a loss function. In some linear-piecewise fitting aspects, the 1D loss function generator 614 may fit a portion of the loss function between consecutive loss function vertices using the standard equations for a line. For example, the 1D loss function generator 614 may fit the loss function between consecutive loss function vertices (X′₂, L₂) and (X′₃, L₃) in FIG. 9A using the following standard equations for a line:

$$m = \frac{{L}_{3} - {L}_{2}}{{X}_{3}^{′} - {X}_{2}^{′}}$$

$$b = {L}_{3} - {mX}_{3}^{′} or b = {L}_{2} - {mX}_{2}^{′}$$

$$L = {mx}^{′} + b$$

As shown in FIG. 9B, the result of this operation may be an L=mx′+b equation for the portion of the loss function between the consecutive loss function vertices.

In some alternative aspects, the 1D loss function generator 614 may use non-linear interpolation to convert a set of loss function vertices into a loss function. In some non-linear loss function interpolation aspects, the non-linear interpolation may be, for example and without limitation, polynomial, quadratic, spline, or k-nearest neighbor (KNN) interpolation. In some non-linear loss function interpolation aspects, the result of the non-linear interpolation may be an L=a₀+a₁x′+a₂x′²+ . . . +aₙx′ⁿ equation for the loss function.

In some aspects, as shown in FIG. 9C, determining a loss value indicative of an error between a prediction value output by the ML model 602 and a corresponding expected value may include the loss function generator 608 using the one-dimensional loss function in X′ and the point on X′ at which the loss value is desired. In some aspects, the loss function generator 608 may determine the desired loss value by calculating L=ƒ(X′). In some aspects in which the line through the prediction value-expected value pair is a vertical line (e.g., as shown in FIG. 8A), the one-dimensional loss function may be a function of prediction value to loss value, and the loss function generator 608 may use the one-dimensional loss function to determine the loss value for the prediction value of the prediction value-expected value pair. In some aspects in which the line through the prediction value-expected value pair is a horizontal line (e.g., as shown in FIG. 8B), the one-dimensional loss function may be a function of estimated value to loss value, and the loss function generator 608 may use the one-dimensional loss function to determine the loss value for the estimated value of the prediction value-expected value pair. In some aspects in which piecewise linear fitting is used to determine the one dimensional loss function (e.g., as shown in FIG. 9B), as shown in FIG. 9C, the loss function generator 608 may use the piece or segment of the loss function defined by the loss function vertices closest to the point at which the loss function is desired to calculate the loss value for the prediction value-expected value pair. In the example illustrated in FIG. 9C, the loss function generator 608 may use the piece of the loss function defined by loss function vertices (X′₂, L₂) and (X′₃, L₃) to determine the loss value for X′.

In some aspects, training the ML model 602 may include the ML optimizer 610 updating the ML model 602 based on the loss values determined by the loss function generator 608 for the prediction value-expected value pairs. In some aspects, the ML optimizer 610 may implement an ML algorithm and provide the determined loss values to the ML algorithm. In some aspects, the ML algorithm may be a supervised ML algorithm, which may request a loss value for every point in the training data set the ML algorithm is trying to match. In some aspects, this may be done by, for each data point, passing the ML model's current prediction and the corresponding expectation (i.e., truth) value to a loss function (e.g., the 1D loss function) and receiving back the gradient and hessian of the determined loss value for each point. In some aspects, the ML algorithm of the ML optimizer 610 may then apply an optimization function to generate model parameter updates that reduce the error between prediction and truth. In some aspects, the optimization function of the ML optimizer 610 may be, for example, gradient descent or one of its descendants (e.g., a stochastic gradient descent (SGD) algorithm or Adam optimization algorithm). In some aspects, this process may repeated until the overall loss is below a threshold, improvements in loss are no longer occurring, and/or the maximum number of iterations is reached.

Some aspects of the invention may be implemented in the Python programming language. An example of an implementation in the Python programming language is shown below. In some aspects, as shown below, the implementation may use linear-piecewise functions for constructing the 1D loss function.

```
#*********************************************************************
class ContourLoss( ):
  def_init_(self):
    self.contour_elevations=None
  #******************************************************************
  def loss(self, y_est, y_true):
    “““
    Compute the objective function loss at each (est, truth) point.
    Args:
      y_est (array of float): model predictions
      y_true (array of float) truth labels
    Returns:
      grad (array of float): objective function gradient at each (est, truth) point.
      hess (array of float): objective function hessian at each (est, truth) point.
    ”””
    # Get the loss info
    grad, hess = np.vectorize(self._gradient_single)(y_est, y_true)
    return grad, hess
  #******************************************************************
  def score(self, y_est, y_true):
    “”
    Get the scoring value from for the loss / objective
    Args:
      y_est (array of float): model predictions
      y_true (array of float) truth labels
    Returns:
      1) (float): Root-sum-of-squares of the gradient at each point.
    “”
    loss, _= self.loss(y_est, y_true)
    return np.sqrt(np.sum(loss ** 2))
  #******************************************************************
  def _find_y(self, contour_pts, x):
    “““
    Get the CGM estimate value that lies on the contour for a given truth glucose value
    Args:
      contour_pts (list of 2-tuple): Parkes t1 contour vertices.
      x (float): True glucose value.
    Returns:
      float: the CGM glucose value that lies on the error grid contour
    ”””
    # decide if interpolation or extrapolation
    if contour_pts[0][0] <= x <= contour_pts[-1][0]:
      return np.interp(x, [i[0] for i in contour_pts], [i[1] for i in contour_pts])
    elif x < contour_pts[0][0]:
      # compute first segment slope and y intercept
      del_x = (contour_pts[1][0] − contour_pts[0][0])
      if del_x != 0:
        m = (contour_pts[1][1] − contour_pts[0][1]) / del_x
        b = contour_pts[0][1] − m * contour_pts[O][0]
        return m * x + b
      else:
        return 0
    else: # contour_pts[−1][0] < x
      # compute last segment slope and y intercept
      del_x = contour_pts[−1][0] − contour_pts[-2][0]
      if del_x != 0:
        m = (contour_pts[-1][1] − contour_pts[-2][1]) / del_x
        b = contour_pts[-1][1] − m * contour_pts[−1][0]
        return m * x + b
      else:
        return 550
  #******************************************************************
  def _get_y_vals(self, y_true):
    pass
  #******************************************************************
  def _get_z_value(self, contour_ys, contour_zs, y):
    “““
    Get the loss gradient and hessian value for the given y
    Args:
      contour_ys (list): CGM estimate contour positions for the truth value under test.
      contour_zs (list): Loss values at the CGM estimate contour positions.
      y (float): actual CGM estimate.
    Returns:
      float: loss gradient value at y.
      float: loss hessian value at y.
    ”””
    # decide if interpolation or extrapolation
    if contour_ys[0] <= y <= contour_ys[−1]:
      idxs = np.array(contour_ys) <= y
      lt_zs = [i for (i, v) in zip(contour_zs, idxs) if v]
      gt_zs = [i for (i, v) in zip(contour_zs, idxs) if not v]
      lt_ys = [i for (i, v) in zip(contour_ys, idxs) if v]
      gt_ys = [i for (i, v) in zip(contour_ys, idxs) if not v]
      m = abs(gt_zs[0] − lt_zs[-1]) / (gt_ys[0] − lt_ys[−1])
      return np.interp(y, contour_ys, contour_zs), m
    elif y < contour_ys[0]:
      # compute first segment slope and y intercept
      m = (contour_zs[1] − contour_zs[0]) / (contour_ys[1] − contour_ys[0])
      b = contour_zs[0] − m * contour_ys[0]
      return m * y + b, m
    else: # contour_pts[−1] < x
      # compute last segment slope and y intercept
      m = 1 / (600 − contour_ys[−1])
      b = contour_zs[−1] − m * contour_ys[−1]
      return m * y + b, m
  #******************************************************************
  def _gradient_single(self, y_est, y_true):
    “““
    Compute model loss
    Args:
      y_est (float): CGM glucose estimate.
      y_true (float): Truth glucose value.
    Returns:
      1) float: loss value (lower is better). Always >= 0.
      2) float: loss slope
    ”””
    # Find the contour y-values at y_true; use to get gradient and hessian
    y_vals = self ._ get_y_vals(y_true)
    grad, hess = self ._ get_z_value(y_vals, self.contour_elevations, y_est)
    # Because z(y_est) is a piecewise-linear function. The integral is quadratic:
    # 1/2 * z**2 + C. Thus z is the abs(gradient) value, but we still need to correctly
    # decide on the constant to get the slope right.
    if y_est < y_true:
      grad *= −1
    return grad, hess
#******************************************************************
class ParkesLoss(ContourLoss):
  def_{——}init_{——}(self, ttype=′Parkes_T1′, weighting=None):
    # Contour vertices
    self.center =[( 0, 0), (550, 550)]
    if ttype.lower() == ′parkes_t1′:
      self.pointsD1E1 = [( 0, 150), ( 35, 155), ( 50, 550)]
      self.pointsC1D1 = [( 0, 100), ( 25, 100), ( 50, 125), ( 80, 215), (125, 550)]
      self.pointsB1C1 = [( 0, 60), ( 30, 60), ( 50, 80), ( 70, 110), (260, 550)]
      self.pointsA1B1 = [( 0, 50), ( 30, 50), (140, 170), (280, 380), (430, 550)]
      self.pointsA2B2 = [( 50, 0), ( 50, 30), (170, 145), (385, 300), (550, 450)]
      self.pointsB2C2 = [(120, 0), (120, 30), (260, 130), (550, 250)]
      self.pointsC2D2 = [(250, 0), (250, 40), (550, 150)]
    else:
      self.pointsDIE1 = [( 0, 200), ( 35, 200), ( 50, 550)]
      self.pointsC1D1 = [( 0, 80), ( 25, 80), ( 35, 90), (125, 550)]
      self.pointsB1C1 = [( 0, 60), ( 30, 60), (280, 550)]
      self.pointsA1B1 = [( 0, 50), ( 30, 50), (230, 330), (440, 550)]
      self.pointsA2B2 = [( 50, 0), ( 50, 30), ( 90, 80), (330, 230), (550, 450)]
      self.pointsB2C2 = [( 90, 0), (260, 130), (550, 250)]
      self.pointsC2D2 = [(250, 0), (250, 40), (410, 110), (550, 160)]
    # Contour Heights: Technically these are the positive square roots
    # C2D2, B2C2, A2B2, Center, A1B1, B1C1, C1D1, D1E1
    self.contour_elevations = [10, 1, 0, 0, 0, 1, 5, 15]
    self.weight_function=weighting
  #******************************************************************
  def _get_y_vals(self, y_true):
    y_vals = [self ._ find_y(self.pointsC2D2, y_true), \
        self._find_y(self.pointsB2C2, y_true), \
        self._find_y(self.pointsA2B2, y_true), \
        self._find_y(self.center, y_true), \
        self._find_y(self.pointsA1B1, y_true), \
        self._find_y(self.pointsB1C1, y_true), \
        self._find_y(self.pointsC1D1, y_true), \
        self._find_y(self.pointsD1E1, y_true), \
        ]
    return y_vals
```

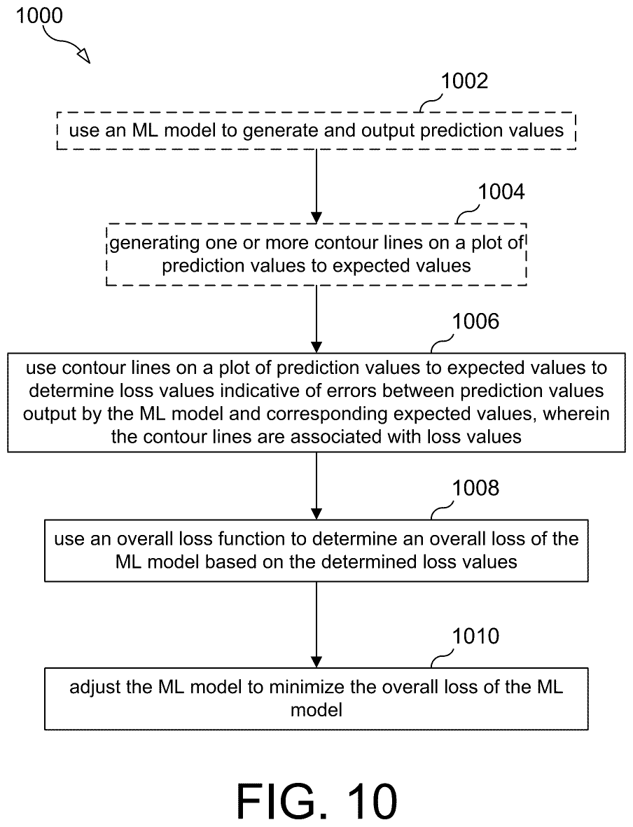

FIG. 10 illustrates a process 1000 for training an ML model 602 according to some aspects. In some aspects, some or all of the steps of the process 1000 may be performed by the ML model training system 600. In some aspects, some or all of the steps of the process 1000 may be performed by the loss function generator 608 and/or the ML optimizer 610 of the ML model training system 600.

In some aspects, as shown in FIG. 10, the process 1000 may include a step 1006 in which the loss function generator 608 uses contour lines on a plot of prediction values to expected values to determine loss values indicative of errors between prediction values output by the ML model 602 and corresponding expected values. In some aspects, the contour lines may be associated with loss values. In some aspects, the contour lines may express an arbitrary loss for regression. In some aspects, the contour lines may account for arbitrary asymmetry. In some aspects, the contour lines may account for clinical practice results. In some aspects, the contour lines may correspond to a clinical significance of glucose misprediction. In some aspects, the contour lines may correspond to areas of a Parkes Error Grid. In some aspects, the contour lines may correspond to areas of Clark Error Grid. However, this is not required, and, in some alternative aspects, the contour lines may relate to different areas of a different data grid (e.g., a weather data grid).

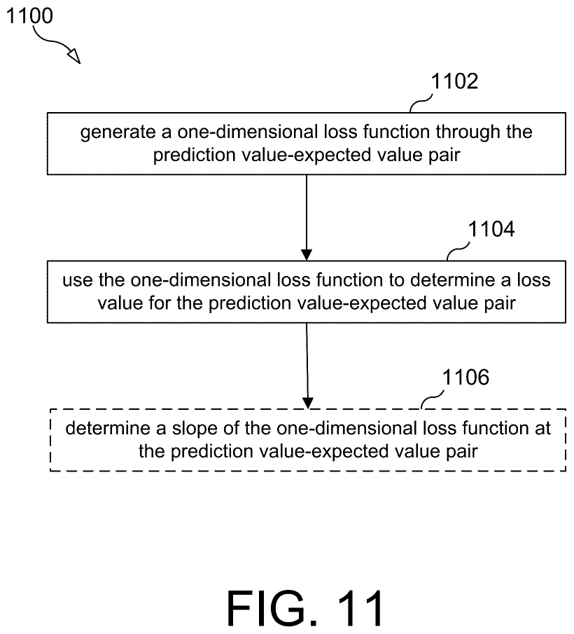

FIG. 11 illustrates a process 1100 for using contour lines to determine loss values according to some aspects. In some aspects, some or all of the steps of the process 1100 may be performed by the ML model training system 600. In some aspects, some or all of the steps of the process 1000 may be performed by the loss function generator 608 of the ML model training system 600. In some aspects, the process 1100 may be performed during step 1006 of the process 1000 for training an ML model 602.

In some aspects, as shown in FIG. 11, the process 1100 may include a step 1102 in which the loss function generator 608 (e.g., the 1D loss function generator 614 of the loss function generator 608), for each prediction value-expected value pair of the prediction values output by the ML model 602 and the corresponding expected values, generates a one-dimensional loss function through the prediction value-expected value pair. In some aspects, as shown in FIGS. 8A-8C, generating the one-dimensional loss function through the prediction value-expected value pair may include the 1D loss function generator 614 determining intersection points including at least a first intersection point at which a line through the prediction value-expected value pair intersects with a first contour line of the contour lines and a second intersection point at which the line through the prediction value-expected value pair intersects with a second contour line of the contour lines.

In some aspects, as shown in FIGS. 8A-8C, generating the one-dimensional loss function in step 1102 may include the 1D loss function generator 614 interpolating and/or extrapolating the one-dimensional loss function from at least the first and second intersection points. In some aspects, as shown in FIGS. 8A-8C, interpolating and/or extrapolating the one-dimensional loss function may use linear interpolation and/or linear extrapolation. However, this is not required, and, in some alternative aspects, interpolating and/or extrapolating the one-dimensional loss function may use non-linear interpolation (e.g., polynomial, quadratic, spline, or KNN interpolation) and/or non-linear extrapolation.

In some aspects, as shown in FIG. 11, the process 1100 may include a step 1104 in which the loss function generator 608, for each prediction value-expected value pair of the prediction values output by the ML model 602 and the corresponding expected values, uses the one-dimensional loss function determined in step 1102 for the prediction value-expected value pair to determine a loss value for the prediction value-expected value pair.

In some aspects (e.g., some vertical line aspects), as shown in FIG. 8A, the first intersection point may include a prediction value of the first contour line having the expected value of the prediction value-expected value pair, the second intersection point may include a prediction value of the second contour line having the expected value of the prediction value-expected value pair, and using the one-dimensional loss function to determine the loss value for the prediction value-expected value pair in step 1104 may include the loss function generator 608 using at least the prediction values of the first and second intersection points and the loss values associated with the first and second contour lines to determine the loss value for the prediction value of the prediction value-expected value pair. In some aspects (e.g., some vertical line aspects), determining the first and second intersection points in step 1102 may include the 1D loss function generator 614, for each of the first and second contour lines: (i) if the expected value of the prediction value-expected value pair is within a range of the expected values of a set of contour line pairs of prediction and expected values of the contour line with each pair of the set of contour line pairs defining a vertex of the contour line, using interpolation to determine the prediction value of the contour line having the expected value of the prediction value-expected value pair, and (ii) if the expected value of the prediction value-expected value pair is outside the range of the expected values of the set of contour line pairs of prediction and expected values of the contour line, using extrapolation to determine the prediction value of the contour line having the expected value of the prediction value-expected value pair. In some aspects (e.g., some vertical line aspects), the one-dimensional loss function may be a function of prediction value to loss value, and the one-dimensional loss function may determine the loss value for the prediction value of the prediction value-expected value pair.

In some aspects (e.g., some horizontal line aspects), as shown in FIG. 8B, the first intersection point may include an expected value of the first contour line having the prediction value of the prediction value-expected value pair, the second intersection point may include an expected value of the second contour line having the prediction value of the prediction value-expected value pair, and using the one-dimensional loss function to determine the loss value for the prediction value-expected value pair in step 1104 may include the loss function generator 608 using at least the expected values of the first and second intersection points and the loss values associated with the first and second contour lines to determine the loss value for the expected value of the prediction value-expected value pair. In some aspects (e.g., some horizontal line aspects), determining the first and second intersection points in step 1102 may include the 1D loss function generator 614, for each of the first and second contour lines: (i) if the predicted value of the prediction value-expected value pair is within a range of a set of contour line pairs of prediction and expected values of the contour line with each pair of the set of contour line pairs defining a vertex of the contour line, using interpolation to determine the expected value of the contour line having the predicted value of the prediction value-expected value pair, and (ii) if the predicted value of the prediction value-expected value pair is outside the range of the predicted values of the set of contour line pairs of prediction and expected values of the contour line, using extrapolation to determine the expected value of the contour line having the predicted value of the prediction value-expected value pair. In some aspects (e.g., some horizontal line aspects), the one-dimensional loss function may be a function of expected value to loss value, and the one-dimensional loss function may determine the loss value for the expected value of the prediction value-expected value pair.

In some aspects, as shown in FIG. 11, the process 1100 may include an optional step 1106 in which the loss function generator 608, for each prediction value-expected value pair of the prediction values output by the ML model 602 and the corresponding expected values, determines a slope of the one-dimensional loss function determined in step 1102 at the prediction value-expected value pair. In some alternative aspects, instead of the loss function generator 608, the ML optimizer 510 may determine the slopes of the one-dimensional loss function at the prediction value-expected value pairs.

In some aspects, as shown in FIG. 10, the process 1000 may include a step 1008 in which the ML optimizer 610 uses an overall loss function to determine an overall loss of the ML model 602 based on the determined loss values. In some aspects, the overall loss function may be a regression loss function. In some aspects, the loss function may be a mean square error loss function. In some aspects, the overall loss function may be a mean absolute error loss function, a mean bias error loss function, a hinge loss function, or a cross-entropy loss function. In some aspects, the overall loss function may be a classification loss function. In some aspects, using the overall loss function to determine the overall loss of the ML model 602 in step 1008 may include the ML optimizer 610, for example, squaring the determined loss values, summing the squared determined loss values, and calculating a square root of the sum.

In some aspects, as shown in FIG. 10, the process 1000 may include a step 1010 in which the ML optimizer 610 adjusts the ML model 602 to minimize the overall loss of the ML model 602. In some aspects, adjusting the ML model 602 to minimize the overall loss of the ML model 602 may include the ML optimizer 610 modifying one or more of the one or more model parameters 612 of the ML model 602. In some aspects, adjusting the ML model 602 may include the ML optimizer 510 using an optimization algorithm to optimize the ML model's parameters with the determined loss values being used as gradients and the determined slopes of the one-dimensional loss functions at the prediction value-expected value pairs being used as Hessians. In some aspects, the optimization algorithm may be a gradient descent algorithm, a stochastic gradient descent algorithm, or an Adam optimization algorithm.

In some aspects, as shown in FIG. 10, the process 1000 may include an optional step 1002 in which the ML model 602 generates the prediction values. In some aspects, the step 1002 may include the ML model 602, for each of the prediction values, receiving one or more model inputs (e.g., of the training data set stored in the training data storage device 604), generating the prediction value (e.g., based on the one or more model inputs and the ML model parameters 612), and outputting the prediction value.

In some aspects, as shown in FIG. 10, the process 1000 may include an optional step 1004 in which the loss function generator 608 receives contour line definitions (e.g., from the contour line data storage device 606). In some aspects, as shown in FIGS. 7A and 7B, the contour line definitions may include, for each of the contour lines, a set of contour line pairs of prediction and expected values for the contour line, and each pair of the set of contour line pairs may define a vertex of the contour line. In some aspects, as shown in FIG. 7C, the contour line definitions may include, for each of the contour lines, a contour line function. In some aspects, each of the contour line functions may be a function of prediction values to expected values. In some alternative aspects, each of the contour line functions may be a function of expected values to prediction values. In some aspects, as shown in FIG. 7D, the contour line definitions may include, for each of the contour lines, parametric functions.

In some aspects (e.g., some aspects in which one or more of the contour lines are defined sets of contour line vertices), the step 1004 may include the loss function generator 608 (e.g., the contour line function generator 612 of the loss function generator 608) generating one or more of the contour lines. In some aspects, as shown in FIGS. 7A and 7B, generating the one or more contour lines may include the contour line function generator 612, for each contour line, interpolating and/or extrapolating the contour line from the set of contour line pairs of prediction and expected values for the contour line. In some aspects, as shown in FIG. 7A, interpolating and/or extrapolating the contour lines may use linear interpolation (e.g., linear-piecewise fitting) and/or linear extrapolation. In some aspects, as shown in FIG. 7B, interpolating and/or extrapolating the contour lines may use non-linear interpolation (e.g., polynomial, quadratic, spline, or KNN interpolation) and/or non-linear extrapolation.

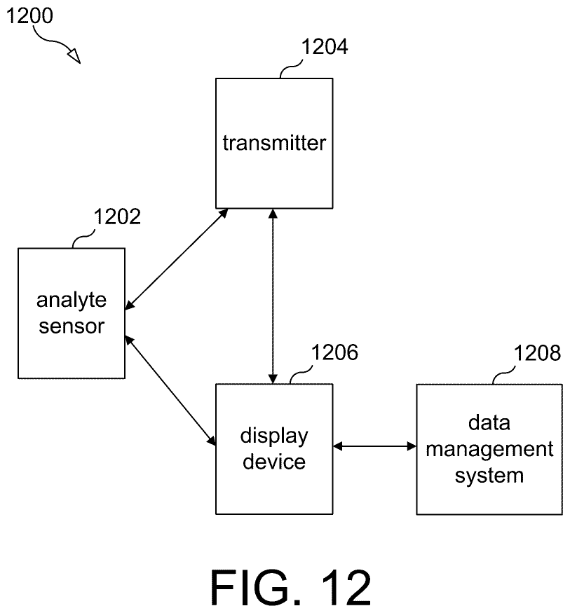

In some blood glucose level prediction aspects in which the ML model inputs include one or more ISF glucose levels and associated time stamps, one or more analyte monitoring systems 1200, such as, for example and without limitation, the analyte monitoring system 1200 shown in FIG. 12, may be used to generate the ML model inputs of the training data set used to train the ML model 602. In some aspects, after the ML model 602 is trained, the ML model 602 may be used by an analyte monitoring system 1200 to predict blood glucose levels based on ISF glucose levels calculated by the analyte monitoring system 1200.

In some aspects, as shown in FIG. 12, the analyte monitoring system 1200 may be a continuous analyte monitoring system (e.g., a continuous glucose monitoring system). In some aspects, the analyte monitoring system 1200 may include an analyte sensor 1202, a transceiver 1204, a display device 1206, and/or a data management system (DMS) 1208 hosted by a remote server or network attached storage hardware.

In some aspects, the sensor 1200 may be small, fully subcutaneously implantable sensor measures analyte (e.g., glucose) concentrations in a medium (e.g., interstitial fluid) of a living animal (e.g., a living human). However, this is not required, and, in some alternative aspects, the analyte sensor 1202 may be a partially implantable (e.g., transcutaneous) sensor or a fully external sensor. In some aspects, the analyte sensor 1202 may be powered by (a) one or more charge storage devices (e.g., one or more batteries) included in the analyte sensor 1202 and/or (b) power received from a source (e.g., the transceiver 1204 and/or the display device 1206) external to the analyte sensor 1202. In some non-limiting aspects, the analyte sensor 1202 may include one or more optical sensors (e.g., one or more fluorometers). In some aspects, the analyte sensor 1202 may be a chemical or biochemical sensor. In some aspects, the analyte sensor 1202 may be a radio frequency identification (RFID) device.

In some aspects, the transceiver 1204 may be an externally worn transceiver (e.g., attached via an armband, wristband, waistband, or adhesive patch). In some aspects, the transceiver 1204 may remotely power and/or communicate with the sensor to initiate and receive the measurements (e.g., via near field communication (NFC) or far field communication). However, this is not required, and, in some alternative aspects, the transceiver 1204 may power and/or communicate with the sensor 1202 via one or more wired connections. In some aspects, the transceiver 1204 may be a smartphone (e.g., an NFC-enabled smartphone). In some aspects, the transceiver 1204 may communicate information (e.g., one or more analyte concentrations and/or one or more sensor measurements) wirelessly (e.g., via a Bluetooth™ communication standard such as, for example and without limitation Bluetooth Low Energy) to a mobile medical application running on a display device 1206 (e.g., a smartphone such as, for example, an NFC-enabled smartphone).

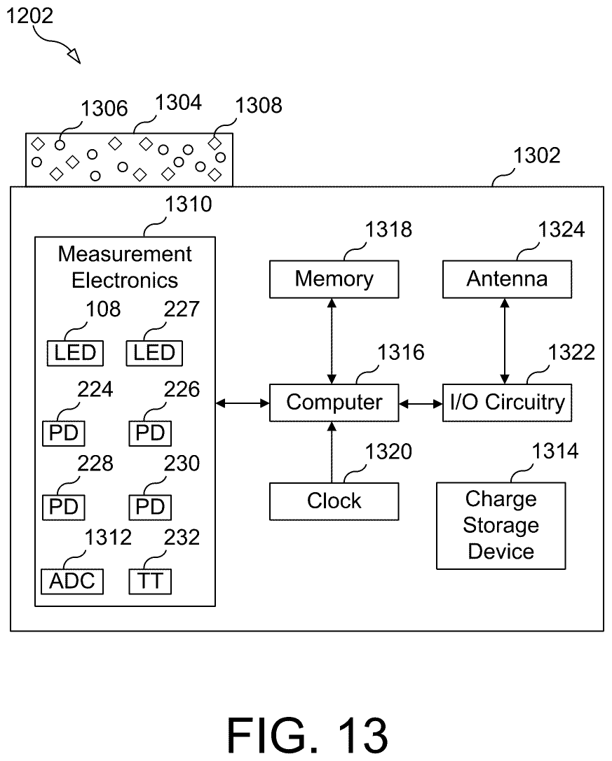

FIG. 13 illustrates an exemplary aspect in which the analyte sensor 1202 of the analyte monitoring system 1200 is a fully implantable electro-optical sensor. However, this is not required, and, in some alternative aspects, the analyte sensor 1202 may be a different type of analyte sensor (e.g., a transcutaneous electrochemical sensor). In some aspects, as shown in FIG. 13, the analyte sensor 1202 may include a sensor housing 1302 (i.e., body, shell, capsule, or encasement), which may be rigid and biocompatible. In some aspects, the sensor housing 1302 may be a silicon tube. However, this is not required, and, in other aspects, different materials and/or shapes may be used for the sensor housing 1302. In some aspects, the analyte sensor 1202 may include a transmissive optical cavity (e.g., within the sensor housing 1302). In some aspects, the transmissive optical cavity may be formed from a suitable, optically transmissive polymer material, such as, for example, acrylic polymers (e.g., polymethylmethacrylate (PMMA)). However, this is not required, and, in other aspects, different materials may be used for the transmissive optical cavity.

In some aspects, the analyte sensor 1202 may include one or more analyte and/or interferent indicators 1304, which may be, for example, polymer grafts or hydrogels coated, diffused, adhered, embedded, or grown on or in one or more portions of the exterior surface of the sensor housing 1302. In some aspects, the one or more analyte and/or interferent indicators 1304, may be porous and may allow the analyte (e.g., glucose) in a medium (e.g., interstitial fluid) to diffuse into the one or more analyte and/or interferent indicators 1304.

In some aspects, as shown in FIG. 13, the one or more analyte and/or interferent indicators 1304 may include analyte indicator molecules 1306 and/or interferent indicator molecules 1308 (e.g., degradation indicator molecules). In some aspects, analyte sensor 1202 may use the analyte indicator molecules 1306 to measure the presence, amount, and/or concentration of an analyte (e.g., glucose, oxygen, cardiac markers, low-density lipoprotein (LDL), high-density lipoprotein (HDL), or triglycerides). In some aspects, the analyte indicator molecules 1306 may use the interferent indicator molecules 1308 to measure in vivo (e.g., ROS induced) signal degradation. In some aspects, in the one or more analyte and/or interferent indicators 1304, the analyte indicator molecules 1306 and/or the interferent indicator molecules 1308 may be copolymerized into a single biocompatible hydrogel. In some aspects, the analyte indicator molecules 1306 and/or the interferent indicator molecules 1308 may have negligible spectral overlap and undergo similar degradation (e.g., similar degradation of boronic acids) in vivo.

In some aspects, the analyte indicator molecules 1306 may have one or more detectable properties (e.g., optical properties) that vary in accordance with (i) the amount or concentration of the analyte in proximity to the analyte and/or interferent indicator 1304 and (ii) an effect on the analyte indicator molecules 1306 (e.g., changes to the analyte indicator molecules 1306). In some aspects, the changes to the analyte indicator molecules 1306 may comprise the extent to which the analyte indicator molecules 1306 have degraded. In some aspects, the degradation may be (at least in part) ROS-induced oxidation. In some aspects, the analyte indicator molecules 1306 may be fluorescent analyte indicator molecules. In some aspects, the analyte indicator molecules 1306 may be distributed throughout the analyte and/or interferent indicator 1304. In some aspects, the analyte indicator molecules 1306 may be phenylboronic-based analyte indicator molecules. However, a phenylboronic-based analyte indicator is not required, and, in some alternative aspects, the analyte sensor 1202 may include different analyte indicator molecules, such as, for example and without limitation, glucose oxidase-based indicators, glucose dehydrogenase-based indicators, and glucose binding protein-based indicators.

In some aspects, the interferent indicator molecules 1308 may have one or more detectable properties (e.g., optical properties) that vary in accordance with changes to the interferent indicator molecules 1308. In some aspects, the interferent indicator molecules 1308 are not sensitive to the amount of concentration of the analyte in proximity to the analyte and/or interferent indicator 1304. That is, in some aspects, the one or more detectable properties of the interferent indicator molecules 1308 do not vary in accordance with the amount or concentration of the analyte in proximity to the analyte and/or interferent indicator 1304. However, this is not required, and, in some alternative aspects, the one or more detectable properties of interferent indicator molecules 1308 may vary in accordance with the amount or concentration of the analyte in proximity to the analyte and/or interferent indicator 1304.

In some aspects, the changes to the interferent indicator molecules 1308 may comprise the extent to which the interferent indicator molecules 1308 have degraded. In some aspects, the degradation may be (at least in part) ROS-induced oxidation. In some aspects, the interferent indicator molecules 1308 may be fluorescent interferent indicator molecules. In some aspects, the interferent indicator molecules 1308 may be distributed throughout the analyte and/or interferent indicator 1304. In some aspects, the interferent indicator molecules 1308 may be phenylboronic-based interferent indicator molecules. However, phenylboronic-based interferent indicator molecules are not required, and, in some alternative aspects, the analyte sensor 1202 may include different interferent indicator molecules 1308, such as, for example and without limitation, amplex red-based interferent indicator molecules, dichlorodihydrofluorescein-based interferent indicator molecules, dihydrorhodamine-based interferent indicator molecules, and scopoletin-based interferent indicator molecules.

In some aspects, the analyte sensor 1202 may measure changes to the analyte indicator molecules 1306 of an analyte and/or interferent indicator 1304 indirectly using the interferent indicator molecules 1308 of the analyte and/or interferent indicator 1304, which may by sensitive to degradation by reactive oxygen species (ROS) but not sensitive to the analyte. In some aspects, the interferent indicator molecules 1308 may have one or more optical properties that change with extent of oxidation and may be used as a reference for measuring and correcting for extent of oxidation of the analyte indicator molecules 1306. In some aspects, the extent to which the interferent indicator molecules 1308 have degraded may correspond to the extent to which the analyte indicator molecules 1306 have degraded. For example, in aspects, the extent to which the interferent indicator molecules 1308 have degraded may be proportional to the extent to which the analyte indicator molecules 1306 have degraded. In some aspects, the extent to which the analyte indicator molecules 1306 have degraded may be calculated based on the extent to which the interferent indicator molecules 1308 have degraded. In some aspects, the analyte monitoring system 1200 may correct for changes in the analyte indicator molecules 1306 using an empiric correlation established through laboratory testing.

In some aspects, the analyte sensor 1202 may include measurement electronics 1310 (e.g., optical measurement electronics). In some aspects, the measurement electronics 1310 may include one or more light sources and/or one or more photodetectors. For example, in some aspects, as shown in FIG. 13, the measurement electronics 1310 may include one or more first light sources 108 that emit first excitation light over a wavelength range that interacts with the analyte indicator molecules 1306 in the analyte and/or interferent indicator 1304. In some aspects, the first excitation light may be ultraviolet (UV) light. In some aspects, the analyte sensor 1202 may include one or more second light sources 227 that emit second excitation light over a wavelength range that interacts with the interferent indicator molecules 1308 in the analyte and/or interferent indicator 1304. In some aspects, the second excitation light may be, for example and without limitation, blue light.

In some aspects, an analyte (e.g., glucose) may bind reversibly to some of the analyte indicator molecules 1306, the analyte indicator molecules 1306 to which the analyte is bound may emit first emission light (e.g., fluorescent light) when irradiated by the first excitation light, and the analyte indicator molecules 1306 to which the analyte is not bound may not emit light (or emit only a small amount of light) when irradiated by the first excitation light. In some aspects, oxidation of the interferent indicator molecules 1308 may cause the interferent indicator molecules 1308 to emit second emission light (e.g., when irradiated by the second excitation light). In some aspects, oxidation of the interferent indicator molecules 1308 may additionally or alternatively cause the absorption of the interferent indicator molecules 1308 (e.g., absorption of the second excitation light by the interferent indicator molecules 1308) to change.

In some aspects, as shown in FIG. 13, the measurement electronics 1310 of the analyte sensor 1202 may also include one or more photodetectors 224, 226, 228 (e.g., photodiodes, phototransistors, photoresistors, or other photosensitive elements). In some aspects, the measurement electronics 1310 of the analyte sensor 1202 may include one or more signal photodetectors 224 sensitive to first emission light (e.g., fluorescent light) emitted by the analyte indicator molecules 1306 such that a signal generated by a signal photodetector 224 is indicative of the level of first emission light of the analyte indicator molecules 1306 and, thus, the amount of analyte of interest (e.g., glucose). In some aspects, the measurement electronics 1310 may include one or more reference photodetectors 226 sensitive to first excitation light that may be reflected from the analyte and/or interferent indicator 1304 such that a signal generated by a photodetector 226 in response thereto is indicative of the level of reflected first excitation light. In some aspects, the analyte sensor 1202 may include one or more interferent photodetectors 228 sensitive to second emission light (e.g., fluorescent light) emitted by the interferent indicator molecules 1308 such that a signal generated by an interferent photodetector 228 in response thereto that is indicative of the level of second emission light of the interferent indicator molecules 1308 and, thus, the amount of degradation (e.g., oxidation). In some aspects, the one or more signal photodetectors 224 may be sensitive to second excitation light that may be reflected from the analyte and/or interferent indicator 1304. In this way, the one or more signal photodetectors 224 may act as reference photodetectors when the one or more light sources 227 are emitting second excitation light.

However, it is not required that the one or more signal photodetectors 224 act as reference photodetectors when the one or more light sources 227 are emitting second excitation light. In some alternative aspects, as shown in FIG. 13, the measurement electronics 1310 of the analyte sensor 1202 may include one or more second reference photodetectors 230 that act as reference photodetectors when the one or more light sources 227 are emitting second excitation light. In some aspects, the one or more second reference photodetectors 230 may be sensitive to second excitation light that may be reflected from the analyte and/or interferent indicator 1304 such that a signal generated by a photodetector 230 in response thereto is indicative of the level of reflected second excitation light.

In some aspects, one or more of the photodetectors 224, 226, 228, 230 may be covered by one or more filters that allow only a certain subset of wavelengths of light to pass through and reflect (or absorb) the remaining wavelengths. In some aspects, one or more filters on the one or more signal photodetectors 224 may allow only a subset of wavelengths corresponding to first emission light and/or the reflected second excitation light. In some aspects, one or more filters on the one or more reference photodetectors 226 may allow only a subset of wavelengths corresponding to the reflected first excitation light. In some aspects, one or more filters on the one or more interferent photodetectors 228 may allow only a subset of wavelengths corresponding to second emission light. In some aspects in which the analyte sensor 1202 includes one or more second reference photodetectors 230, one or more filters on the one or more second reference photodetectors 230 may allow only a subset of wavelengths corresponding to the reflected second excitation light.

In some aspects, as shown in FIG. 13, the measurement electronics 1310 of the analyte sensor 1202 may include one or more temperature transducers 232. In some aspects, the measurement electronics 1310 may include one or more light source drivers, one or more amplifiers, one or more analog-to-digital convertors (ADCs) 1312, one or more comparators, and/or one or more multiplexors. In some aspects, the one or more ADCs 1312 may convert analog signals output by the photodetectors 224, 226, 228, 230 and/or one or more temperature transducers 232 to digital signals.

In some aspects, as shown in FIG. 13, the analyte sensor 1202 may include a charge storage device 1314, a computer 1316, a memory 1318, a clock 1320, an input/output (I/O) circuit 1322, and/or an antenna 1324. In some aspects, the I/O circuit 1322 may include I/O digital circuitry and/or I/O analog circuitry. In some aspects, the antenna 1324 may be electrically connected to the I/O circuit 1322, which may use current flowing through the antenna 1324 to generate power for the sensor 1202 and/or to extract data from the current. In some aspects, the 1322 may also convey data (e.g., to the transceiver 1204 and/or display device 1206) by modulating the current the flowing through the antenna 1324. In some aspects, the I/O circuit 1322 may be electrically connected to and be powered by the charge storage device 1314. In some aspects, although not shown in FIG. 13, the analyte sensor 1202 may include multiple sensing devices, and the antenna 1324 may be electrically connected to the circuitry of the multiple sensing devices.

In some aspects, the charge storage device (CSD) 1314 may provide power to the clock 1320 and to the computer 1316. In some aspects, the CSD-powered clock 1320 may provide a continuous clock for driving circuitry of the sensor 1202 even when the sensor 1202 is not receiving power from an external device (e.g., the transceiver 1204 and/or the display device 1206). In some aspects, the computer 1316 may use the continuous clock output of the clock 1320 to keep track of time and initiate autonomous, self-powered analyte measurements when appropriate (e.g., at periodic intervals, such as, for example, every minute, every two minutes, every 5 minutes, every 10 minutes, every 15 minutes, every half-hour, every hour, every two hours, every six hours, every twelve hours, or every day). In some aspects, the computer 1316 may control the measurement electronics 1310 to perform an autonomous analyte measurement sequence, and the results of the autonomous analyte measurement may be stored in the memory 1318. The autonomous analyte measurements may be stored in the memory 1318. In some aspects, the I/O circuit 1322 may convey one or more of the stored measurements to the external device (e.g., the transceiver 1204 and/or the display device 1206) at a later time. For example, in some request aspects, the I/O circuit 1322 may convey one or more of the stored measurements in response to the analyte sensor 1202 receiving and decoding a measurement data request from the transceiver 1204 and/or the display device 1206. In some alternative aspects, the I/O circuit 1322 may convey one or more of the stored measurements in response to detecting that the transceiver 1204 and/or display device 1206 is present (e.g., when an electrodynamic field generated by the transceiver 1204 and/or display device 1206 induces a current in the antenna 1324 of the analyte sensor 1202). In some aspects in which the analyte sensor 1202 include multiple sensing devices, although not shown in FIG. 13, the CSD 1314 may be electrically connected to the circuitry of the multiple sensing devices.

In some aspects, the memory 1318 may be a nonvolatile storage medium. In some aspects, the memory 1318 may be an electrically erasable programmable read only memory (EEPROM). However, in some alternative aspects, other types of nonvolatile storage media, such as flash memory, may be used. In some aspects, the memory 1318 may include an address decoder. In some aspects, the memory 1318 may store measurement information autonomously generated while the sensor 1202 is powered from the charge storage device 1314. In some aspects, the memory 1320 may additionally or alternatively store one or more time-stamps identifying when the measurement data was generated, sensor calibration data, a unique sensor identification, setup information, and/or integrated circuit calibration data. In some aspects, the unique identification information may, for example, enable full traceability of the sensor 1202 through its production and subsequent use.

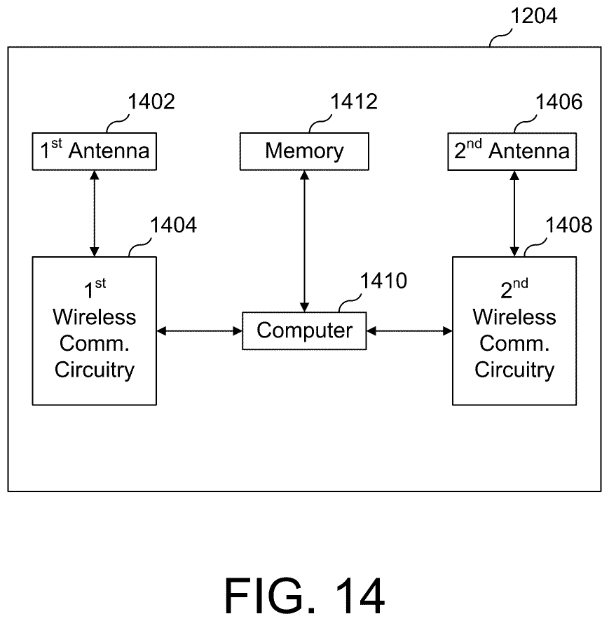

FIG. 14 illustrates an exemplary aspect in which the transceiver 1204 of the analyte monitoring system 1200 is a wireless transceiver (e.g., a wireless on-body transceiver). However, this is not required, and, in some alternative aspects, the transceiver 1204 may be a different type of transceiver (e.g., a transceiver having a wired connection to the analyte sensor 1202). In some aspects, as shown in FIG. 14, the transceiver 1204 may include a first antenna 1402, first wireless communication circuitry 1404, a second antenna 1406, second wireless communication circuitry 1408, a computer 1410, and/or a memory 1412. In some aspects, the computer 1410 may control the overall operation of the transceiver 1204.

In some aspects, the transceiver 1204 may include a sensor interface device. In some aspects, the sensor interface device of the transceiver 1204 may include the first antenna 1402 and the first wireless communication circuitry 1404. In some aspects, the first wireless communication circuitry 1404 may enable the transceiver 1204 to communicate directly with the analyte sensor 1202. In some aspects, the transceiver 1204 and the sensor 1202 may communicate using NFC (e.g. at a frequency of 13.56 MHz). In some aspects, the first antenna 1402 of the transceiver 1204 may include an inductor (e.g. flat antenna, loop antenna, etc.) that is configured to permit adequate field strength to be achieved when brought within adequate physical proximity to the antenna 1324 of the sensor 1202.

In some aspects, the transceiver 1204 may use the first antenna 1402 and the first wireless communication circuitry 1404 to receive sensor data from the analyte sensor 1202. In some aspects, the computer 1410 may store the received sensor data in the memory 1412. In some aspects, the memory 1412 may be non-volatile and/or capable of being electronically erased and/or rewritten. In some aspects, the memory 1412 may be, for example and without limitations a Flash memory.

In some aspects, the received sensor data may include light measurements, temperature measurements, and time stamps. In some aspects, the computer 1410 may use the sensor data to predict blood glucose levels. In some aspects, the computer 1410 may use the trained ML model 602 to predict blood glucose levels. In some aspects, the computer 1410 may use the sensor data to calculate ISF glucose levels, and the ML model 602 may predict blood glucose levels based on the calculated ISF glucose levels. In some alternative aspects, the ML model 602 may predict blood glucose levels based on the sensor data directly. In some aspects, the computer 1410 may store the predicted blood glucose levels in the memory 1412.

In some aspects, the transceiver 1204 may include a display interface device. In some aspects, the display device interface device may include the second antenna 1406 and the second wireless communication circuitry 1408. In some aspects, the second wireless communication circuitry 1408 may enable wireless communication by the transceiver 1204 with one or more external devices, such as, for example, one or more personal computers, one or more other transceivers 1204, and/or display devices 1206 via the second antenna 1406. In some aspects, the second wireless communication circuitry 1408 may employ one or more wireless communication standards to wirelessly transmit data. The wireless communication standard employed may be any suitable wireless communication standard, such as an ANT standard, a Bluetooth standard, or a Bluetooth Low Energy (BLE) standard (e.g., BLE 4.0). In some aspects, the second antenna 1406 may be, for example and without limitation, a Bluetooth antenna.

In some aspects in which the transceiver 1204 predicts blood glucose levels, the transceiver 1204 may use the second antenna 1406 and the second wireless communication circuitry 1408 to convey predicted blood glucose levels to the display device 1206. In some aspects in which the transceiver 1204 predicts and conveys blood glucose levels, the transceiver 1204 may additionally convey the sensor data to the display device 1206. In some alternative aspects, the transceiver 1204 may not predict blood glucose levels. In some aspects in which the transceiver 1204 does not predict blood glucose levels, the transceiver 1204 may use the second antenna 1406 and the second wireless communication circuitry 1408 to convey sensor data to the display device 1206, and the display device 1206 may use the sensor data to predict blood glucose levels.

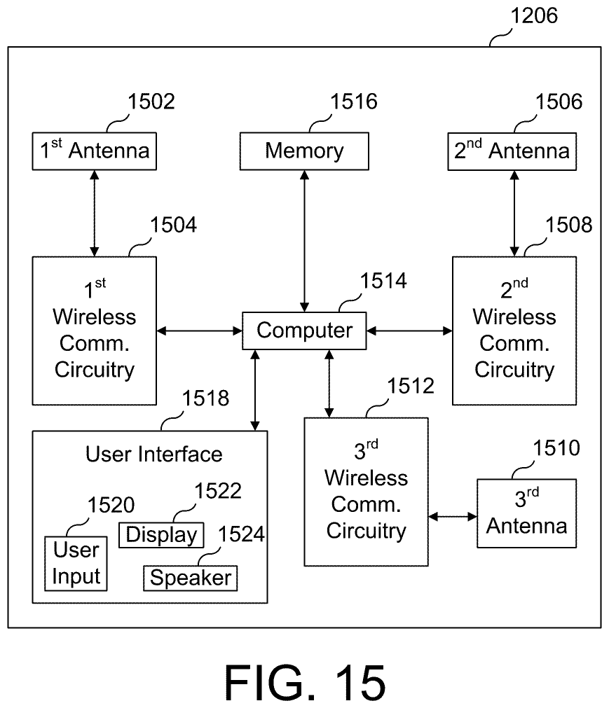

FIG. 15 is a block diagram of the display device 1206 of the analyte monitoring system 1200 according to some aspects. In some aspects, as shown in FIG. 15, the display device 1206 may include a first antenna 1502, first wireless communication circuitry 1504, second antenna 1506, second wireless communication circuitry 1508, third antenna 1510, third wireless communication circuitry 1512, a computer 1514, a memory 1516, and/or a user interface 1518. In some aspects, the computer 1514 may control the overall operation of the display device 1206.

In some aspects, the display device 1206 may include a sensor interface device. In some aspects, the sensor interface device of the display device 1206 may include the first antenna 1502 and the first wireless communication circuitry 1504. In some aspects, the first wireless communication circuitry 1504 may enable the display device 1206 to communicate directly with the analyte sensor 1202. In some aspects, the display device 1206 and the sensor 1202 may communicate using NFC (e.g. at a frequency of 13.56 MHz). In some aspects, the first antenna 1502 of the display device 1206 may include an inductor (e.g. flat antenna, loop antenna, etc.) that is configured to permit adequate field strength to be achieved when brought within adequate physical proximity to the antenna 1324 of the sensor 1202.

In some aspects, the display device 1206 may use the first antenna 1502 and the first wireless communication circuitry 1504 to receive sensor data from the analyte sensor 1202. In some aspects, the computer 1514 may store the received sensor data in the memory 1516. In some aspects, the memory 1516 may be non-volatile and/or capable of being electronically erased and/or rewritten. In some aspects, the memory 1516 may be, for example and without limitations a Flash memory.

In some aspects, the received sensor data may include light measurements, temperature measurements, and time stamps. In some aspects, the computer 1514 may use the sensor data to predict blood glucose levels. In some aspects, the computer 1514 may use the trained ML model 602 to predict blood glucose levels. In some aspects, the computer 1514 may use the sensor data to calculate ISF glucose levels, and the ML model 602 may predict blood glucose levels based on the calculated ISF glucose levels. In some alternative aspects, the ML model 602 may predict blood glucose levels based on the sensor data directly. In some aspects, the computer 1514 may store the predicted blood glucose levels in the memory 1516.

In some aspects, the display device 1206 may include a transceiver interface device. In some aspects, the transceiver interface device may include the second antenna 1506 and the second wireless communication circuitry 1508. In some aspects, the second wireless communication circuitry 1508 may enable wireless communication by the display device 1206 with one or more external devices, such as, for example, one or more personal computers, one or more transceivers 1204, and/or one or more other display devices 1206 via the second antenna 1506. In some aspects, the second wireless communication circuitry 1508 may employ one or more wireless communication standards to wirelessly transmit data. The wireless communication standard employed may be any suitable wireless communication standard, such as an ANT standard, a Bluetooth standard, or a Bluetooth Low Energy (BLE) standard (e.g., BLE 4.0). In some aspects, the second antenna 1506 may be, for example and without limitation, a Bluetooth antenna.

In some aspects, the display device 1206 may use the second antenna 1506 and the second wireless communication circuitry 1508 to receive sensor data and/or predicted blood glucose levels from the transceiver 1204. In some aspects, the computer 1514 may store the received sensor data and/or the received predicted blood glucose levels in the memory 1516. In some aspects, the computer 1514 may use the sensor data to predict blood glucose levels. In some aspects (e.g., some aspects in which the display device 1206 does not receive predicted blood glucose levels from transceiver 1204), the computer 1514 may use the trained ML model 602 to predict blood glucose levels based on the sensor data received from the transceiver 1204. In some aspects, the computer 1514 may use the sensor data to calculate ISF glucose levels, and the ML model 602 may predict blood glucose levels based on the calculated ISF glucose levels. In some alternative aspects, the ML model 602 may predict blood glucose levels based on the sensor data directly. In some aspects, the computer 1514 may store the predicted blood glucose levels in the memory 1516.

In some aspects in which the display device 1206 includes the third antenna 1510 and the third wireless communication circuitry 1512, the third antenna 1510 and the third wireless communication circuitry 1512 may enable the display device 1206 to communicate with one or more remote devices (e.g., smartphones, servers, and/or personal computers) via wireless local area networks (e.g., Wi-Fi), cellular networks, and/or the Internet. In some aspects, the third wireless communication circuitry 1512 may employ one or more wireless communication standards to wirelessly transmit data. In some aspects, the third antenna 1510 may be, for example and without limitation, a Wi-Fi antenna and/or one or more cellular antennas.

In some aspects in which the display device 1206 includes the user interface 1518, the user interface 1518 may include a display 1522 and/or a user input 1520. In some aspects, the display 1522 may be a liquid crystal display (LCD) and/or light emitting diode (LED) display. In some aspects, the user input 1520 may include one or more buttons, a keyboard, a keypad, and/or a touchscreen. In some aspects, the computer 1514 may control the display 1522 to display data (e.g., predicted blood analyte levels, blood analyte trend information, alerts, alarms, and/or notifications). In some aspects, the user interface 1518 may include one or more of a speaker 1524 (e.g., a beeper) and a vibration motor, which may be activated, for example, in the event that a condition (e.g., a hypoglycemic or hyperglycemic condition) is met.

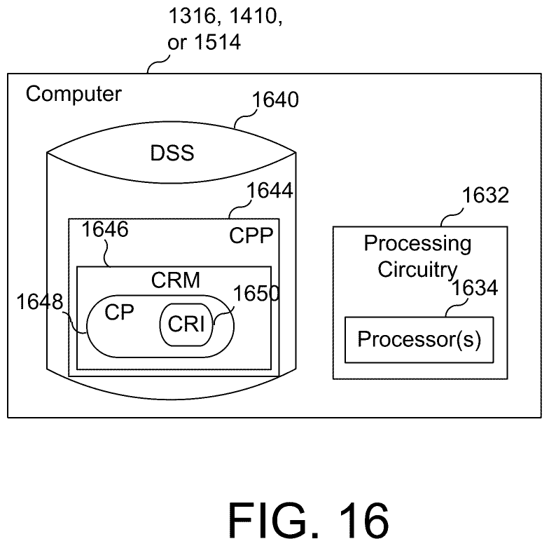

FIG. 16 is a block diagram of an aspect of a computer (e.g., the computer 1316 of the analyte sensor 1202, the computer 1410 of the transceiver 1204, and/or the computer 1514 of the display device 1206) of the analyte monitoring system 1200 or of the ML model training system 600. As shown in FIG. 16, in some aspects, the computer may include processing circuitry 1632 and/or one or more circuits, such as an application specific integrated circuit (ASIC), field-programmable gate arrays (FPGAs), a logic circuit, and the like. The processing circuitry 1632 may include one or more processors 1634 (e.g., one or more general purpose microprocessors). In some aspects, the computer may include a data storage system (DSS) 1640. The DSS 1640 may include one or more non-volatile storage devices and/or one or more volatile storage devices (e.g., random access memory (RAM)). In aspects where the computer includes processing circuitry 1632, the DSS 1640 may include a computer program product (CPP) 1644. CPP 1644 may include or be a computer readable medium (CRM) 1646. The CRM 1646 may store a computer program (CP) 1648 comprising computer readable instructions (CRI) 1650. In some aspects in which the computer is the computer 1514 of the display device 1206, the CRM 1646 may store, among other programs, the MMA, and the CRI 1650 may include one or more instructions of the MMA. The CRM 1646 may be a non-transitory computer readable medium, such as, but not limited, to magnetic media (e.g., a hard disk), optical media (e.g., a DVD), solid state devices (e.g., random access memory (RAM) or flash memory), and the like. In some aspects, the CRI 1650 of computer program 1648 may be configured such that when executed by processing circuitry 1632, the CRI 1650 causes the computer to perform steps described below (e.g., steps described above with reference to processes 1000 and 1100). In other aspects, the computer may be configured to perform steps described herein without the need for a computer program. That is, for example, the computer may consist merely of one or more ASICs. Hence, the features of the aspects described herein may be implemented in hardware and/or software.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

What is claimed is:

1. A method for training a machine learning (ML) model, the method comprising:
using contour lines on a plot of prediction values to expected values to determine loss values indicative of errors between prediction values output by the ML model and corresponding expected values, wherein the contour lines are associated with loss values;
using an overall loss function to determine an overall loss of the ML model based on the determined loss values; and
adjusting the ML model to minimize the overall loss of the ML model.

2. The method of claim 1, further comprising generating the contour lines, wherein each of the contour lines is generated based on a set of contour line pairs of prediction and expected values for the contour line, and each pair of the set of contour line pairs defines a vertex of the contour line.

3. The method of claim 2, wherein generating the contour lines comprises, for each contour line, interpolating and/or extrapolating the contour line from the set of contour line pairs of prediction and expected values for the contour line.

4. The method of claim 1, wherein each of the contour lines is a function of prediction values to expected values.

5. The method of claim 1, wherein each of the contour lines is a function of expected values to prediction values.

6. The method of claim 1, wherein each of the contour lines is defined by parametric functions.

7. The method of claim 1, wherein using the contour lines to determine the loss values comprises, for each prediction value-expected value pair of the prediction values output by the ML model and the corresponding expected values:
generating a one-dimensional loss function through the prediction value-expected value pair; and
using the one-dimensional loss function to determine a loss value for the prediction value-expected value pair.

8. The method of claim 7, wherein generating the one-dimensional loss function through the prediction value-expected value pair comprises determining intersection points including at least a first intersection point at which a line through the prediction value-expected value pair intersects with a first contour line of the contour lines and a second intersection point at which the line through the prediction value-expected value pair intersects with a second contour line of the contour lines.

9. The method of claim 8, wherein:
the first intersection point comprises a prediction value of the first contour line having the expected value of the prediction value-expected value pair;
the second intersection point comprises a prediction value of the second contour line having the expected value of the prediction value-expected value pair; and
using the one-dimensional loss function to determine the loss value for the prediction value-expected value pair comprises using at least the prediction values of the first and second intersection point and the loss values associated with the first and second contour lines to determine the loss value for the prediction value of the prediction value-expected value pair.

10. The method of claim 9, wherein determining the first and second intersection points includes, for each of the first and second contour lines:
if the expected value of the prediction value-expected value pair is within a range of the expected values of a set of contour line pairs of prediction and expected values of the contour line with each pair of the set of contour line pairs defining a vertex of the contour line, using interpolation to determine the prediction value of the contour line having the expected value of the prediction value-expected value pair; and
if the expected value of the prediction value-expected value pair is outside the range of the expected values of the set of contour line pairs of prediction and expected values of the contour line, using extrapolation to determine the prediction value of the contour line having the expected value of the prediction value-expected value pair.

11. The method of claim 8, wherein:
the first intersection point comprises an expected value of the first contour line having the prediction value of the prediction value-expected value pair;
the second intersection point comprises an expected value of the second contour line having the prediction value of the prediction value-expected value pair; and
using the one-dimensional loss function to determine the loss value for the prediction value-expected value pair comprises using at least the expected values of the first and second intersection points and the loss values associated with the first and second contour lines to determine the loss value for the expected value of the prediction value-expected value pair.

12. The method of claim 11, wherein determining the first and second intersection points includes, for each of the first and second contour lines:
if the predicted value of the prediction value-expected value pair is within a range of a set of contour line pairs of prediction and expected values of the contour line with each pair of the set of contour line pairs defining a vertex of the contour line, using interpolation to determine the expected value of the contour line having the predicted value of the prediction value-expected value pair; and
if the predicted value of the prediction value-expected value pair is outside the range of the predicted values of the set of contour line pairs of prediction and expected values of the contour line, using extrapolation to determine the expected value of the contour line having the predicted value of the prediction value-expected value pair.

13. The method of claim 8, wherein the line through the prediction value-expected value pair is neither vertical nor horizontal.

14. The method of claim 8, wherein generating the one-dimensional loss function comprises interpolating and/or extrapolating the one-dimensional loss function from at least the first and second intersection points.

15. The method of claim 7, wherein:
the one-dimensional loss function is a function of prediction value to loss value; and
the one-dimensional loss function determines the loss value for the prediction value of the prediction value-expected value pair.

16. The method of claim 7, wherein:
the one-dimensional loss function is a function of expected value to loss value; and
the one-dimensional loss function determines the loss value for the expected value of the prediction value-expected value pair.

17. The method of claim 7, further comprising determining a slope of the one-dimensional loss function at the prediction value-expected value pair.

18. The method of claim 17, wherein adjusting the ML model comprises using an optimization algorithm to optimize the ML model's parameters with the determined loss values being used as gradients and the determined slopes of the one-dimensional loss functions at the prediction value-expected value pairs being used as Hessians.

19. The method of claim 1, wherein adjusting the ML model to minimize the overall loss of the ML model includes modifying one or more parameters of the ML model.

20. The method of claim 1, wherein the contour lines express an arbitrary loss for regression.

21. The method of claim 1, wherein the contour lines account for arbitrary asymmetry.

22. The method of claim 1, wherein the contour lines account for clinical practice results.

23. The method of claim 1, wherein the contour lines correspond to a clinical significance of glucose misprediction.

24. The method of claim 1, wherein the contour lines correspond to areas of a Parkes Error Grid.

25. The method of claim 1, wherein the contour lines correspond to areas of Clark Error Grid.

26. A machine learning (ML) model training system configured to:
use contour lines on a plot of prediction values to expected values to determine loss values indicative of errors between prediction values output by the ML model and corresponding expected values, wherein the contour lines are associated with loss values;
use an overall loss function to determine an overall loss of the ML model based on the determined loss values; and
adjust the ML model to minimize the overall loss of the ML model.

27. The ML model training system of claim 26, wherein the apparatus comprises processing circuitry and a memory, the memory includes instructions executable by the processing circuitry, whereby the apparatus is operative to perform the loss values determining, the overall loss determining, and the ML model adjusting.
